(19) United States
(12) Patent Application Publication
(10) Pub. No.: US 2026/0252915 A1
(43) Pub. Date: Aug. 27, 2026

(54) Automated System and Method for Failure Prediction, Anomaly Detection, Intelligent Alarms and Autonomous Control Logic Using Data Imputation

(71) Applicant: Weatherford Technology Holdings, LLC, Houston, TX (US)

(72) Inventors: Anupam Nath, Mumbai (IN); Swetha Namburu, Hyderabad (IN); Rakesh Rai, Katy, TX (US); Yibin Wang, Houston, TX (US); Aaron Kistler, Houston, TX (US); Eduardo A. Marin, Houston, TX (US); Roman Molotkov, Katy, TX (US); Abhishek Das, Houston, TX (US)

(21) Appl. No.: 19/071,563

(22) Filed: Mar. 5, 2025

Related U.S. Application Data
(60) Provisional application No. 63/763,208, filed on Feb. 25, 2025.

(51) Int. Cl. G06N 5/04; G06N 5/022

(52) U.S. Cl. CPC G06N 5/04; G06N 5/022

(57) ABSTRACT

A processing system integrates missing data imputation, failure prediction, autonomous control logic, anomaly detection, and intelligent alarm notification for artificial lift units within a single framework for complete automation of an analytics workflow. An imputation model is trained to fill missing data in datasets. The trained imputation model imputes missing values in raw time-series data from artificial lift units to generate a complete dataset. An analytics function processes this imputed dataset to make predictions regarding the artificial lift units. Based on these predictions, the system configures automated instructions to optimize operations and implements these instructions for use on the artificial lift units, ensuring improved performance and efficiency. The framework can be automatically re-tuned and re-trained using feedback from real-time data drift.

### CROSS-REFERENCE TO RELATED APPLICATIONS

This application claims the benefit of U.S. Provisional Appl. No. 63/763,208 filed Feb. 25, 2025, which is incorporated herein by reference in its entirety.

### FIELD OF THE DISCLOSURE

The subject matter of the present disclosure is directed systems and methods for integrating missing data imputation, failure prediction, autonomous control logic, anomaly detection, and intelligent alarm notification in artificial lift units. The disclosed systems and methods can be implemented within a single framework for complete automation of an analytics workflow. Additionally, this framework can be automatically re-tuned and re-trained using feedback from real-time data drift.

### BACKGROUND OF THE DISCLOSURE

The performance of failure prediction models often relies on the quality of data. Machine learning algorithms can identify correlations and patterns on complete datasets. However, incorrect data collection from sensors, communication errors, and sudden malfunctions in controller units may result in missing values. Ignoring these partially measured data samples makes the data incomplete and may yield bias in analysis of the features. Imputing the missing data can give unbiased results, which may help data analysis for predictive modeling, especially in a production environment.

One way to impute missing data uses statistical techniques, such as mean/median/linear regression/interpolation imputation. Statistical techniques, such as Inter Quantile Ranges (IQR), gaussian distribution-based mean and covariance measures, Bayesian and voting methods, have been used to impute missing sensor data. For example, U.S. Pat. No. 11,089,108 to Shah et al. is directed to a statistical technique for anomaly detection, missing data imputation, and consumption prediction in energy data. U.S. Pat. No. 8,788,291 to Srinivasan et al. is directed to a statistical technique for estimation of missing data in a multivariate longitudinal setup. U.S. Pat. No. 11,450,413 to Sarrafzadeh et al. is also directed to a statistical technique for missing data imputation. In general, the statistical techniques require valid assumptions to be made for the missing data. If the assumptions are not entirely valid, the statistical techniques may tend to deviate the outcome of the analysis. For example, the statistical techniques may underestimate the variance of the imputed values and may require strong assumptions introducing bias, if applied to multivariate datasets. Moreover, the statistical techniques are simple and can be applied for a short length of missing data, but these statistical techniques cannot capture temporal patterns in time series data.

Other ways have been used to impute missing data. U.S. Pat. No. 11,113,337 to Bandyopadhyay et al. is directed to a technique for imputing missing data in a sensor data sequence with missing data. In this method, a candidate value in missing time instances is imputed using semantic learning of features in a sensor data sequence.

Du et al.'s “Saits: Self-attention-based imputation for time series,” Expert Systems with Applications 219 (2023) is directed to self-attention imputation models, such as are widely applied due to their better quality of imputation and improved speed. The SAITS (Self-Attention Imputation for Time Series) algorithm explores the joint optimization training and reconstruction approach that learns the underlying data distribution from partially observed time series data and estimates reasonably close missing values.

U.S. Pat. No. 10,592,368 to Guo, et al. is directed to imputation of missing value for sequential data. In this imputation technique, a sequential system is proposed for imputing corrupted data using autoregressive recurrent neural network (RNN). The autoregressive RNN methods are highly susceptible to compounding errors and time consuming due to memory constraints.

Although the above techniques may be useful for particular purposes and outcomes, the subject matter of the present disclosure is directed to overcoming, or at least reducing the effects of, one or more of the problems set forth above.

### SUMMARY OF THE DISCLOSURE

According to the present disclosure, a method is implemented with processing equipment associated with one or more artificial lift units. The method comprises: training, with the processing equipment, an imputation model configured to impute any missing data in a given dataset; obtaining, at the processing equipment, raw time-series data for the one or more artificial lift units; preprocessing, with the processing equipment, the raw time-series data into an evaluation dataset; imputing, with the imputation model of the processing equipment, imputed data for any missing data in the evaluation dataset to produce an imputed dataset; predicting, with an analytics function of the processing equipment, at least one prediction for the one or more artificial lift units from the imputed dataset; configuring, with the processing equipment, at least one automated instruction in response to the at least one prediction; and implementing, with the processing equipment, the at least one automated instruction for use at the one or more the artificial lift units.

Training the imputation model can involve: preprocessing the raw time-series data into a training dataset; applying a mask to underlying data in at least a portion of the training dataset to produce masked data; imputing, with the imputation model, estimated data for the masked data; estimating an error between the underlying data and the estimated data; and configuring the imputation model to reduce the error.

The step of predicting, with the analytics function of the processing equipment, the at least one prediction for the one or more artificial lift units from the imputed dataset can involve: training a first failure prediction model of the analytics function with first data that is non-imputed; training a second failure prediction model of the analytics function with second data that is imputed; preprocessing the raw time-series data into a training dataset and a test dataset; predicting, with the first failure prediction model, first failure predictions from non-imputed versions of the training dataset and the test dataset; imputing, with the imputation model, imputed versions of the training dataset and the test dataset; predicting, with the second failure prediction model, second failure predictions from the imputed versions of the training dataset and the test dataset; correlating between the first and second failure predictions; and configuring the at least one prediction based on the correlation.

To impute, with the imputation model of the processing equipment, the imputed data for any missing data in the evaluation dataset to produce the imputed dataset, the imputed data can be imputed with a Self-Attention Imputation for Time Series algorithm for the imputation model. For example, training the imputation model can comprise learning relationships across time steps and features, and preserving dependencies between the features by minimizing errors for all of the features at once with a joint loss function in a multivariate joint optimization training process.

Learning the relationships across the time steps and the features can comprise learning, in self-supervised learning of a masked learning task (MLT) algorithm, from underlying patterns in input data and the dependencies between the time steps and the features to reconstruct masked values of the input data based on an indication in the joint loss function of how well the masked values are recovered. Preserving the dependencies between the features can comprise reconstructing, in self-attention encoding of an observed reconstruction task (ORT) algorithm, a reconstruction of observed values in the input data based on a difference in the joint loss function between the reconstruction and the observed values.

The method can further comprise tuning hyperparameters of step size, artificial missing rate size, epoch, batch size, dropout, attention dropout, and weighting for the Self-Attention Imputation for Time Series algorithm by: iterating on the step size and the artificial missing rate size in a first stage to tune a tuned step size and a tuned artificial missing rate size while the Epoch, the batch size, the dropout, the attention dropout, and the weighting are fixed; iterating on the dropout and the attention dropout in a second stage to tune a tuned dropout and a tuned attention dropout while using the tuned step size and the tuned artificial missing rate size from the first stage and while the Epoch, the batch size, and the weighting are fixed; and iterating on the weighting in a third stage to tune a weighting while using the tuned step size, the tuned artificial missing rate size and while the Epoch and the batch size are fixed. The weighting can include a first weight for a masked learning task (MLT) algorithm and a second weight for an observed reconstruction task (ORT) algorithm.

For one or more artificial lift units, a programmable storage device having program instructions stored thereon for causing processing equipment can perform a method according to the above.

According to the present disclosure, a system is used for one or more artificial lift units. The system comprises communication equipment and processing equipment. The communication equipment has network interfaces in communication with one or more networks. The processing equipment is in communication with the communication equipment. The processing equipment is configured to: train an imputation model configured to impute any missing data in a given dataset; obtain raw time-series data for the one or more artificial lift units; preprocess the raw time-series data into an evaluation dataset; impute, with the imputation model, imputed data for any missing data in the evaluation dataset to produce an imputed dataset; predict, with an analytics function, at least one prediction for the one or more artificial lift units from the imputed dataset; configure at least one automated instruction in response to the at least one prediction; and implement the at least one automated instruction for use at the one or more the artificial lift units.

The foregoing summary is not intended to summarize each potential embodiment or every aspect of the present disclosure.

### BRIEF DESCRIPTION OF DRAWINGS

FIG. 1 illustrates an enterprise system according to the present disclosure for monitoring and controlling artificial lift systems.

FIG. 2 illustrates an automated analytics framework of the enterprise system according to the present disclosure.

FIG. 3A illustrates details of an imputation module according to the present disclosure.

FIG. 3B illustrates details of a Self-Attention Imputation for Time Series algorithm for the imputation module of the present disclosure.

FIG. 4 illustrates an example of using imputation for testing a failure prediction model according to the present disclosure.

FIG. 5 illustrates a process of pre-processing, pre-training, and testing an imputation model according to the present disclosure.

FIG. 6 illustrates a process of imputing missing data in a dataset using the imputation model according to the present disclosure.

FIG. 7 illustrates a process of tuning hyper-parameters for the imputation model in three stages according to the present disclosure.

FIG. 8 illustrates a comparison of actual values and imputed values for pump discharge pressure in time series sensor data.

FIG. 9 illustrates a comparison of actual values and imputed values for motor vibration when missing consecutively in time series sensor data.

FIG. 10 illustrates a comparison of actual values and imputed values when several feature values are missing at the same time in time series sensor data.

FIG. 11A illustrates a first graph showing model prediction probability of a non-imputed failure prediction model using example data for a first example well.

FIG. 11B illustrates a second graph showing model prediction probability of an imputed failure prediction model using the example data for the first example well.

FIG. 12A illustrates a first graph showing model prediction probability of a non-Imputed failure prediction model using example data for a second example well.

FIG. 12B illustrates a second graph showing model prediction probability of an imputed failure prediction model using the example data for the second example well.

FIG. 13A illustrates a first graph showing model prediction probability of a non-imputed failure prediction model using example data for a third example well.

FIG. 13B illustrates a second graph showing model prediction probability of an imputed failure prediction model using the example data for the third example well.

### DETAILED DESCRIPTION OF THE DISCLOSURE

In the techniques of the present disclosure, a multi-variate time series imputation model estimates missing data using a joint optimization learning approach. The algorithm learns missing values from an artificial masking and reconstruction process to produce accurate approximations of data between time steps. The customized imputation model converges to a distribution of observed data by calculating Mean Absolute Error (MAE) and by tuning hyper-parameters for the imputation model.

### A. PROCESSING SYSTEM

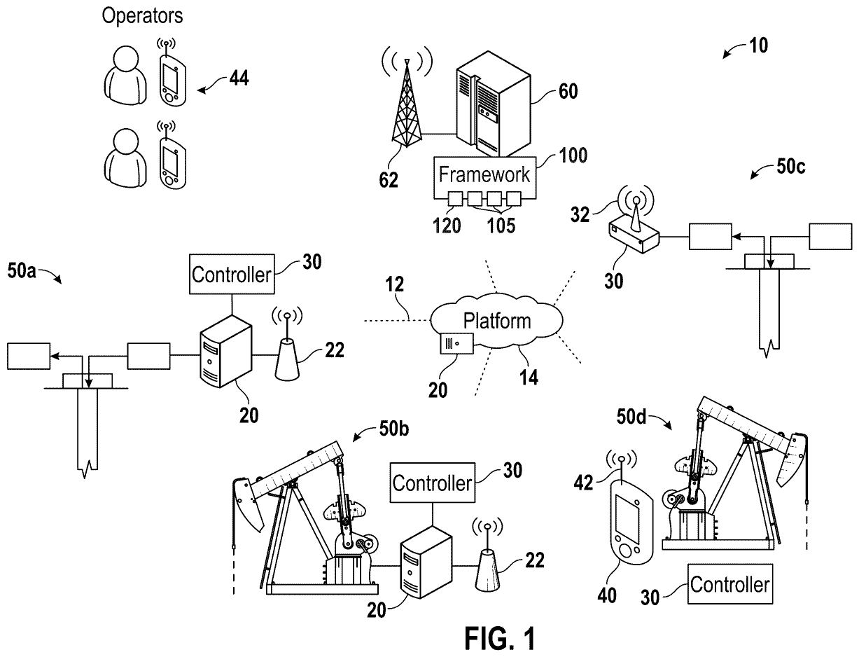

Referring to FIG. 1, processing equipment 10 (e.g., a processing system or an enterprise system) monitors and controls several artificial lift units 50 at various wellsites to improve the operations of the various artificial lift units 50. As will be appreciated, the artificial lift units 50 installed at different wellsites may have different capacities, operating requirements, maintenance schedules, life spans, etc. In fact, the processing system 10 can monitor and control several types of artificial lift units 50, including hydraulic jet pump (HJP), gas lift (GL), plunger lift (PL), gas assisted plunger lift (GA-PL), reciprocating rod pump (RRP), hydraulic piston pump (HPP), progressive cavity pump (PCP), electronic submersible pump (ESP), etc. Moreover, the artificial lift units 50 may be serviced by different technicians and may be operated by different operators 44.

The processing system 10 provides an automated platform that monitors and controls a number of typical, non-optimal, or deleterious “conditions” that affect the artificial lift units 50. These conditions can include inefficiencies, low production, damage, alarms, alerts, imbalance, over pumping, under pumping, over injection, under injection, etc., as discussed in more detail herein. The processing system 10 helps deal with all the differences between the types of artificial lift units 50, conditions, and the like by integrating the sensing, monitoring, and control of the artificial lift units 50 in the enterprise system's automated platform. To do this, the processing system 10 has system computing deployed in a number of locations in a network arrangement.

In general, the processing equipment or system 10 as disclosed herein can include a distributed processing system, a client-server system, or an enterprise processing system having processing components (20, 30, 40, 60, etc.) connected together by one or more networks. The processing system 10 as disclosed herein can include a local processing device 20 connected locally to the one or more artificial lift units 50, and a remote processing device 60 connected remotely to the one or more artificial lift units 50. Communications in the processing system 10 can be via wired communication, wireless communication, radio signal, cellular, satellite, Internet protocol, etc.

Depending on processing capabilities, the processing system 10 can be a centralized system, such as a client-server system or an enterprise system, having a remote processing device 60 (e.g., data center) of a cloud computing platform 14 connected to other components of the processing system 10 via one or more networks 12. The processing system 10 can include control devices 20 integrated throughout the processing system 10. For its part, the cloud computing platform 12 may be provided by a service platform, such as Microsoft Azure, Google Cloud Platform (GCP), Amazon Web Services (AWS), HiveMQ, and the like. Dedicated control devices 20 for artificial lift units 50 can communicate to the cloud computing platform 12 for access by the remote processing device 60 or other central location.

The control device 20 can be used in a server-client system to handle monitoring and control of several artificial lift units 50. Alternatively, the control device 20 may be a computer to locally handle monitor and control of a specific artificial lift unit 50. In general, a control device 20 can be available at a central location, such as a service facility of the cloud computing platform 14. A control device 20 can be available directly at an artificial lift unit 50 having a configured controller 30, and a control device 20 can be in communication with several artificial lift units 50. Additionally, a control device 20 can be positioned at a multi-well pad having remote terminal units and controllers 30 for several artificial lift units 50. As will be appreciated, a remote terminal unit (RTU) is an electronic device having a microprocessor that can interface with components at a wellsite using a telemetry protocol, such as a SCADA (supervisory control and data acquisition) system or the like. Unlike traditional SCADA systems with limited data storage and scheduled data polling, however, the control device 20 can store high-frequency data at the wellsite and can transmit data in real time to the operator's back-office SCADA system at a remote processing device 60 and/or transmit in real time to the cloud computing platform 14. These and other arrangements of the system computing and network communications can be used in the disclosed processing system 10.

Unlike traditional SCADA systems with limited data storage and sporadic data pulls, the processing system 10 can store unlimited data in the cloud computing platform 14 and push it to operators in real time. The processing system 10 learns from this steady stream of data without programming to optimize parameters of the artificial lift units 50 (e.g., to optimize stroke and pump fillage for a rod lift unit, to optimize pump discharge pressure in an ESP system, etc.). The processing system 10 may only send alerts when needed. Preferably, the processing system 10 uses MQTT protocol for high bandwidth data transfer.

In general, some control devices 20 are installed in the field at wellsites, while some control devices 20 are installed remotely at central processing locations or throughout the cloud computing platform 14. Each of the control devices 20 in the field generally includes a power input, a processing unit, memory, communication ports, and other electronic components in an environmental housing. Wired and wireless communications can be available. In this way, the control device 20 in the field can be installed as a standalone automation device or as an addition to existing equipment.

Each of the control devices 20 has communication components 22 for communicating information (signals, measurements, controls, user interface screens, graphs, etc.) locally to users and remotely over one or more communication networks, which can be wired, wireless, satellite, cellular, or other form of network. The communications of the control devices 20 can be between control devices 20 and with users 44, controllers 30, portable control units 40, and other components disclosed herein.

The communicated information can be shared among the elements of the processing system 10. For example, the communicated information can be communicated directly with the operators 44 or communicated with other control devices 20 for access by the operators 44. For example, an artificial lift unit 50 having an installed controller 30 can communicate directly with the operators 44, can communicate with the control device 20, can communicate with a control device 20 of another pumping unit 50, and/or can communicate with a control device 20 designated for multiple artificial lift units 50. As will be appreciated, these and any number of possible communication arrangements can be used.

The control device 20 provides real-time control for artificial lift units 50. For example, using real-time data, the control device 20 can control each stroke or injection cycle of the artificial lift unit 50. The controls are automated with preset algorithms, which can improve production, increase efficiency, and identify problems. Through the monitoring and control, for example, the processing system 10 can reduce over and under pumping in rod-lift units 50 and can reduce over and under injection in gas-lift units 50.

One type of artificial lift unit 50a as shown in FIG. 1 has a control device 20 and a controller 30 to monitor operation of the artificial lift unit 50a. Some of the operational controls provided by the controller 30 can include typical operating instructions, measurements, and other details related to common operations of the artificial lift unit 50a. However, according to the present disclosure, the control device 20 further includes features allowing the artificial lift unit 50a to be monitored and controlled by the processing system 10 for conditions so proactive, automated steps can be taken to optimize the artificial lift unit 50a, to alter the unit's operation to account for the condition at least temporarily, to alert the condition to technicians and operators 44, and to perform other functions as disclosed herein. The control device 20 can use its communication equipment 62 to communicate the monitored condition and can receive instructions remotely or locally to handle the condition.

Sensors of the controller 30 can be permanently installed on the artificial lift unit 50. Sensor data is periodically collected by the control device 20 for long term storage. The control device 20 can be used to manage the calculations automatically and to provide remote indication of the monitored conditions. Users (i.e., technicians 30 and operators 32) can use a mobile device in the field or can use remote devices to connect to the control device 20. Users can download data history and can perform other functions. The control device 20 can connect to the cloud computing platform 14 directly for access by the users, to upload history to a web application, etc. The uploaded data can further be used for advanced data analytics.

As another example, one artificial lift unit 50b as shown in FIG. 1 can be a reciprocating rod pump unit having a control device 20 and a controller 30 to monitor operation of the artificial lift unit 50b. The control device 20 can be part of or can interface with the controller 30 of the artificial lift unit 50.

In yet another example, one artificial lift unit 50c may have a configured controller 30 to monitor operation of the artificial lift unit 50c. Although the artificial lift unit 50c may have a controller configured for typical operation and automated control as disclosed herein, the artificial lift unit 50c may not include a control device 20 that includes specific features allowing the artificial lift unit 50c to be monitored and controlled for certain conditions so proactive steps can be taken to optimize the artificial lift unit 50c, to alter its operation to account for the condition at least temporarily, etc. Instead, the controller 30 can use its communication equipment 32 to communicate the monitored conditions and can receive instructions remotely or locally from a control device 20.

Yet another artificial lift unit 50d may have a controller 42 for its typical operation. However, the artificial lift unit 50d may not include a control device 20, and the controller 42 may not be preconfigured for automated control. Instead, a remote processing device 60 can be used on the artificial lift unit 50d. The remote processing device 60 includes features to communicate with a control device 20 to monitor and control for conditions so proactive steps can be taken to optimize the artificial lift unit 50c, to alter its operation to account for the condition at least temporarily, etc. The remote processing device 60 can use its communication equipment 62 to send information and receive instructions remotely or locally.

For a gas lift unit 50a as shown here, the control device 20 can provide high-frequency data logging and storage and instantaneous intelligent alerts via MQTT protocol. The control device 20 can detect slugging, can send intelligent alerts, and can autonomously control gas-injection rates.

For rod lift units 50b, 50d, such as shown here in FIG. 1, the control device 20 can detect various conditions, such as balance issues, tagging, gearbox torque, high/low loads, high rod stress, excessive friction, and downhole valve issues. The control device 20 minimizes the need for manual intervention by detecting load violations and receiving notifications on any device. The artificial lift unit 50 can be shut down by the control device 20 based on a detected event or alarm.

The control device 20 can provide high-frequency data logging and storage and can send instantaneous intelligent alerts via MQTT protocol. The control device 20 can autonomously control idle time, detect out-of-balance conditions, identify min/max loads and rod stress, monitor load span, recognize real-time pump card, calculate PIP calculation, and calculate downhole pump card.

Although four types of artificial lift units 50a-d are shown, it will be appreciated that a given artificial lift unit 50 as part of the disclosed processing system 10 can have other configurations of the salient components disclosed herein with more or less autonomous and manual capabilities.

As part of the control and monitoring, the processing system 10 also trains and configures various system modules, models, and other analytic functions used throughout the processing system 10, including failure prediction models, intelligent alarm models, anomaly detection models, automated control logic, and other analytic functions used throughout the processing system 10. To do this training and configuration, the processing system 10 imputes missing data that may occur during the integrated sensing, monitoring, and control of the artificial lift units 50 and uses the imputed data for more complete datasets to perform and update the analytic functions. As briefly shown, the processing system 10 includes an automated analytics framework 100 having an imputation module 120 to impute missing data used in the training and configuring of the analytics functions 105. The automated analytics framework 100 connects together the different analytics functions 105 into a workflow and imputes missing data to improve the models, modules, functions, and analysis in the processing system 10.

The automated analytics framework 100 is shown here located at a centralized location, such as the remote processing device 60 (e.g., data center). However, the automated analytics framework 100 can be implemented anywhere in the processing system 10. For example, the automated analytics framework 100 includes software that can operate on one or more processing devices anywhere in the processing system 10. In general, the framework can be implemented on a single workstation or deployed in a network connected environment.

As noted above, the analytics framework 100 can be used as part of the processing system 10, which has a number of distributed control devices 20 and controllers 30 out in the field at wellsites collecting data. The control devices 20 and controllers 30 can perform local analysis, make analysis decisions, and implement corrective changes locally. The automated analysis framework 100 is connected to (or can be part of) that distributed arrangement in the processing system 10.

The analytics framework 100 can operate offline or online. In an offline mode of operation, the analytics framework 100 is not connected in real time to the distributed components (e.g., control devices 20 and/or controllers 30) in the field. The distributed components (20, 30) collect sensor data, and the collected data can be communicated to the analytics framework 100 offline. Alternatively, the analytics framework 100 can be connected online to the distributed components (20, 30) to process and analyze data in real time (or near real time).

Operating either offline or online, the imputation module 120 of the analytics framework 100 evaluates the data for missing data issues and can impute data so the analytics functions 105 (e.g., a failure prediction model, intelligent alarm model, automated control logic, etc.) can make predictions, analysis, and decisions based on a more complete dataset.

In the end, the analytics framework 100 performs analysis on the collected data, imputes any data for missing data, and performs failure prediction modeling and the like. The analytics framework 100 produces results, which can be sent back as various outputs to the distributed components (20, 30). The results can include automated controls, supervised controls, unsupervised controls, instructions, updated models, software updates, threshold adjustments, logic, recommendations, and other outputs set to the distributed components (20, 30) of the processing system 10 to impact operations. These outputs are configured to be implemented or used at the distributed components (20, 30) to improve operations.

During operations, for example, one of the artificial lift units 50a-d may develop a certain monitored condition requiring automated control. As just an example, some monitored conditions suitable for automated control of a rod pumping unit include imbalance, tagging, under pumping, over pumping, and others as disclosed herein. Some monitored conditions suitable for automated control of a gas lift unit include under injection, over injection, and others as disclosed herein.

Depending on the configuration of the artificial lift unit 50a-d, the monitored condition may be communicated remotely for handling or may be handled locally. For example, some of the artificial lift units 50a-d having control devices 20 can determine and handle the condition on their own. The monitored condition can also be communicated to the operators 44, other control devices 20, other artificial lift units 50, etc. In some circumstances, other artificial lift units 50a-d may have a controller 30 that can only determine and communicate the monitored condition for handling by a control device 20 on the network 52. Automated controls can be communicated back for implementation by the properly configured controller 30.

Either way, the analytics framework 100 can be informed of the monitored conditions through the processing system 10. The analytics framework 100 optimizes operations by monitoring parameters, performing calculations, determining deleterious conditions, and providing outputs for the artificial lift unit 50a-d. In this way, the analytics framework 100 can configure operations in a proactive way to deal with various conditions of the artificial lift unit 50a-d as they occur.

### A. ANALYTICS FRAMEWORK

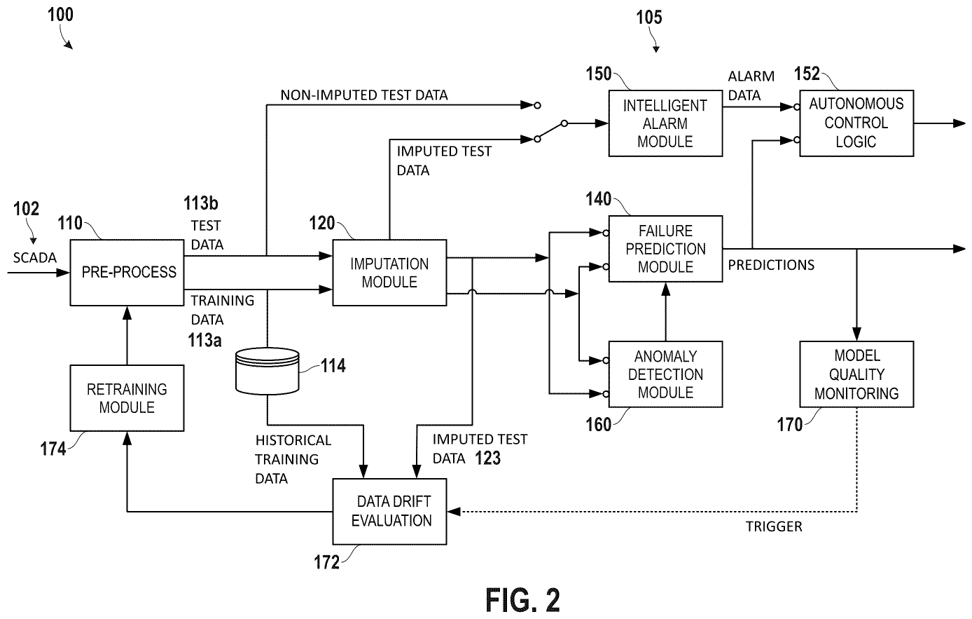

As noted above, the processing system 10 of FIG. 1 uses an analytics framework 100. An example of the analytics framework 100 of the present disclosure is illustrated in FIG. 2. The analytics framework 100 receives input data, namely raw time-series data that can be input from Supervisory Control and Data Acquisition (SCADA). The analytics framework 100 then processes the raw time-series data in a machine learning pipeline (workflow) and outputs results (e.g., predictions, updated models, alarms, autonomous controls, etc.) to send back to control devices (20), controllers (30), and other system components in the processing system 10. To process the input and provide the output, the analytics framework 100 includes a pre-processing module 110, an imputation module 120, and analytics functions 105 implemented in software, hardware, or both as the case may be. The analytics functions 105 include a failure prediction module 140, an intelligent alarm module 150, an anomaly detection module 160, autonomous control logic 152, a model quality monitoring module 170, a data drift evaluation module 172, and a retraining module 174.

In the analytics framework 100, the collected data goes through all the layers of analysis and uses artificial intelligence (AI) machine learning techniques to impute data that is missing in the input datasets. The failure prediction module 140 and intelligent alarms module 150 combine physics modelling to the datasets. Signals, configurations, and other information can be sent out automatically to optimize the controllers (30) and control devices (20) at the wellsites. In this way, the analytics framework 100 can operate as a virtual process to seamlessly optimize well systems in an autonomous way.

Overall, the imputed data produced by the imputation module 120 can improve the performance of the analytics functions 105, such as the failure prediction module 140, the intelligent alarm module 150, and the anomaly detection module 160. The improved output of these analytics functions 105 can eventually improve the execution of the autonomous control logic 152 used by control devices (20), controllers (30), and other system components in the processing system 10.

In the analytics framework 100, the raw time-series data 102 can include wellsite data for sensor values and calculated attributes from hundreds of wellsites. For example, the raw time-series data in Electrical Submersible Pump (ESP) lift units (50) can include analysis data having pressure sensor values, temperature sensor values, failure histories with complete failure information, and downtime histories for the wellsites.

Looking at the workflow in more detail, the pre-processing module 110 is a first data processing step in the machine learning pipeline. The pre-processing module 110 receives input data 102 (e.g., raw time-series data) and performs data cleaning, data sampling, data validity check, data splitting, feature scaling, and normalization. Additionally, the pre-processing module 110 also segregates relevant features for modelling and validates data ranges into a relevant unit system.

The data cleaning ensures that the time-series data is precise, consistent, and error free because incorrect data may cause negative impact to overall performance of the system. The data cleaning essentially removes unwanted observations and duplicate records, removes structural issues like inconsistencies in data formats, and uses naming conventions to streamline the dataset. The data sampling process ensures sampling the time-series data into uniform data representations. For example, each sensor feature may have a different scanning interval of 5-minute samples, 30-minute samples per day, etc., which need to be made uniform for all the features.

The data validity check identifies “good” (i.e., valid) well data for further processing. The time-series data for each wellsite is labelled as valid or invalid based on the data type checks, range checks, and the operating status of the wellsites. Furthermore, the data splitting process partitions the time-series data for modelling into a training dataset and a test dataset, as shown in FIG. 2. For example, time-series data from 80% of valid wells may be used for the training dataset, and time-series from 20% the valid wells may be used for the test dataset.

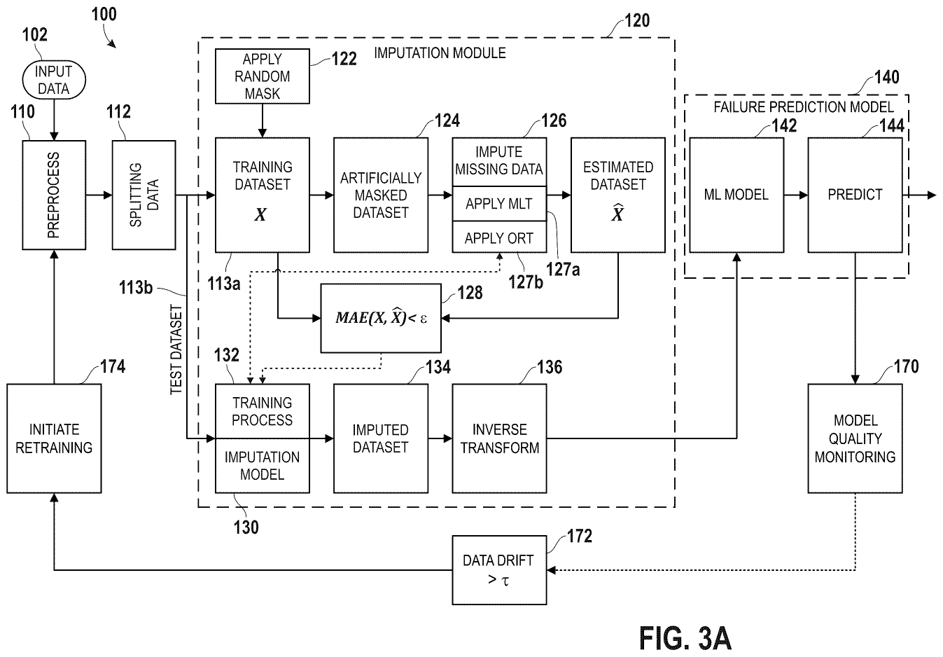

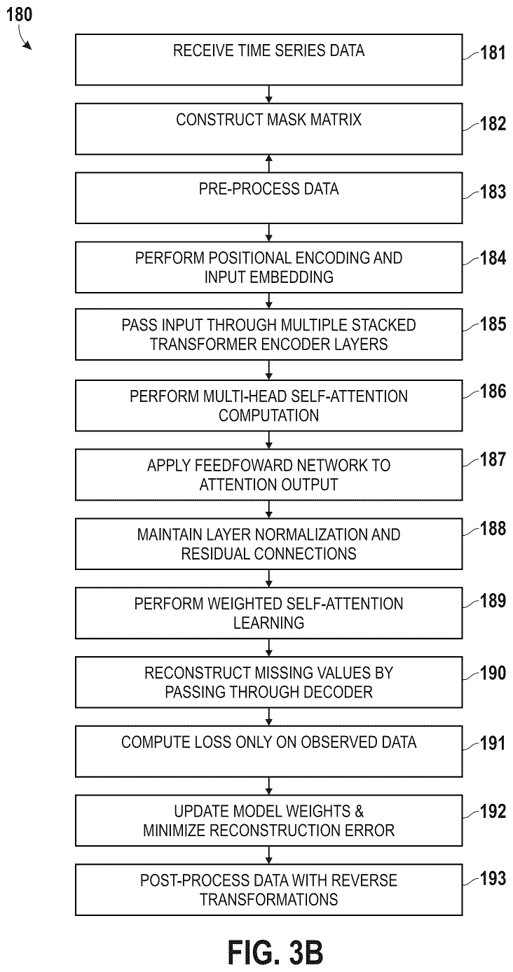

The pre-processing module 110 also performs feature scaling and normalization. The feature scaling standardizes features in the time-series data at a fixed range to handle values with highly varying magnitudes. If scaling is not done, the models of the analytics framework 100 can add bias, giving more weight to higher magnitude values and giving less weight to lower magnitude values. Normalization transforms the features into standard scale between 0 and 1, based on minimum and maximum values of the given features. The selected features along with its normalized features form the training dataset and the test dataset, which are then fed to the imputation module 120 of the analytics framework 100. (Further details of the imputation module 120 are shown in FIG. 3 discussed below.)

The imputation module 120 receives training data 113a in the training dataset and test data 113b in the test dataset from the pre-processing module 110, performs data imputation on missing data to make more complete datasets, and outputs the imputed training dataset and imputed test dataset, both having data imputed for missing data in the original datasets). The output datasets are then passed to the failure prediction module 140 and the anomaly detection module 160, which perform analysis. For example, the failure prediction module 140 provides failure predictions, which can be passed to the system components (e.g., control devices (20), controllers (30), etc.) for use in predicting failures of the artificial lift units (50) at the wellsites.

At the same time, the non-imputed and imputed test datasets from the input and the output stages of the imputation module 120 are fed to the intelligent alarm module 150. Overall, the intelligent alarm module 150 generates alarms using various types of measured sensor data, physics-based well model data, and trends. The intelligent alarm module 150 can provide a variety of alarm notifications to monitor alarm states and overall status of a single wellsite or a large group of wellsites. The intelligent alarm data can be reported any time a data scan is performed, or as part of a daily scheduled process for estimation and allocation. The alarm settings allow the system components (e.g., control devices (20), controllers (30), etc.) to configure the alarm thresholds and reduce the sensitivity of the analytics framework 100.

As noted above, the alarm data is generated using the non-imputed and imputed test datasets. Therefore, the number of alarms captured based on the imputed dataset will be increased when compared to alarms based on the non-imputed dataset. As expected, missing sensor data can impact the generation of an alarm in the intelligent alarm module 150. The imputation module 120 of the present disclosure can thereby improve the generation of alarms by the intelligent alarm module 150. The output of the intelligent alarm module 150 in combination with or without the failure prediction module 140 can improve the operational efficiency of the autonomous control logic 152.

As shown, the alarm data is fed to the autonomous control logic 152. Likewise, the anomaly detection module 160 receives the imputed test dataset and the imputed training dataset from the output of the imputation module 120, detects any anomalies therein, and outputs anomaly data, which is fed to the failure prediction module 140. In turn, the failure predictions from the failure prediction module 140 are fed to the autonomous control logic 152.

The anomaly detection module 160 predicts data anomalies and outliers that may have occurred due to incorrect sensor measurements, component defects, and the like. The anomaly detection module 160 uses multivariate statistical machine learning (ML) techniques to address challenges associated with petroleum datasets. These challenges can include excessive noise, component defects, high dimensionality, sensor trends, non-stationarity, and heterogeneous characteristics of artificial lift systems.

Using these fed inputs, the autonomous control logic 152 can configure autonomous controls and can output controls and tasks for use by system components (e.g., control devices (20), controllers (30), etc.). For example, the autonomous control logic defines control logic and schedules tasks for well optimization functions. The logic can provide autonomous control capabilities for various types of artificial lift units (50). For example, the autonomous control logic can optimize pump fillage in an artificial lift unit (50) to maximize a target production without manual intervention. For instance, the autonomous control logic can prevent liquid loading, maintains target production, optimizes lift gas, and stabilizes flowing bottom hole pressure. Finally, the autonomous control logic can also provide autonomous control in related systems, such as gas injection, water injection, and steam injection.

All the while, a feedback loop is performed in the analytics framework 100. As will be appreciated, drifting in real-time data over time can degrade the performance of the failure prediction module 140 and the anomaly detection module 160. The feedback loop in the analytics framework 100 can address this data drift issue by automatically retraining and aligning the analytics framework 100. The quality of the predictions from the failure prediction module 140 is monitored by the model quality monitoring module 170 to satisfy certain requirements, such as business requirements. Based on the feedback, the data drift evaluation module 172 and the retraining module 174 are triggered to align the imputation module 120 to match with recent trends in the raw time-series data and maintain quality.

In the feedback loop, historical training datasets before imputation are stored in a database 114 for later access. As the failure predictions are output, the model quality monitoring module 170 monitors the failure predictions produced by the failure prediction module 140 and tracks and analyzes the predictions to evaluate the model performance in real-time production environments. When model performance declines, the model quality monitoring module 170 triggers data drift evaluation and ensures that the model quality remains accurate over time. For instance, the model quality monitoring module 170 analyzes defined evaluation metrics, such as a confusion matrix, precision, accuracy, and average prediction window. These metrics are compared with previous results. Based on the comparison, the model quality monitoring module 170 triggers the data drift evaluation module 172.

The data drift evaluation module 172 receives the triggers and measures the drift in the statistical properties of the input data that the failure prediction module 140 received during production operations. To do this, the data drift evaluation module 172 accesses the unimputed training data 113a in the historical training datasets from the database 114 and receives the latest imputed dataset 123 after the imputation module 120. The data drift evaluation module 172 evaluates the drift in the datasets relative to one or more thresholds. For example, the data drift evaluation module 172 measures the distribution of drift between past historical data and present imputed data. The variation in statistical properties of sensor values can be detected over time to monitor whether there is a change in distribution of training data features and production data. Drift threshold(s) t can be configured based on the magnitude of critical features in the datasets.

If the data drift exceeds the threshold(s), the data drift evaluation module 172 initiates a retraining module (174) for the imputation module 120. The retraining module 174 can thereby align the imputation module 120 with recent data trends and can keep the imputation module 120 up to date. To do this, the retraining module 174 is initiated if the measured drift crosses the threshold(s) t, and the retraining module 174 adds new test cases in the data that caused the drift in the raw time series dataset.

### B. IMPUTATION MODULE

Looking now at FIG. 3A, the imputation module 120 is described in more detail in relation to the failure prediction module 140 and the feedback loop. As noted above, time-series input data 102 is pre-processed by the pre-processing module 110, and a data splitting module 112 splits the data into a training dataset 113a and a test dataset 113b for input into imputation module 120.

The imputation module 120 learns a latent representation of the complete data, capturing underlying correlations between variables in the time-series data. The imputation module 120 can use techniques, such as autoencoders, variational autoencoders (VAEs), or deep generative models to encode incomplete data into a latent space and reconstruct missing values. As will be appreciated, the multivariate variables may have correlations and dependencies. Therefore, training in the imputation module 120 can exploit the multivariate structure of the dataset to infer missing values by leveraging information from correlated variables. As will be appreciated, Bayesian networks, Gaussian processes, or attention mechanisms in deep learning models can be used to capture dependencies.

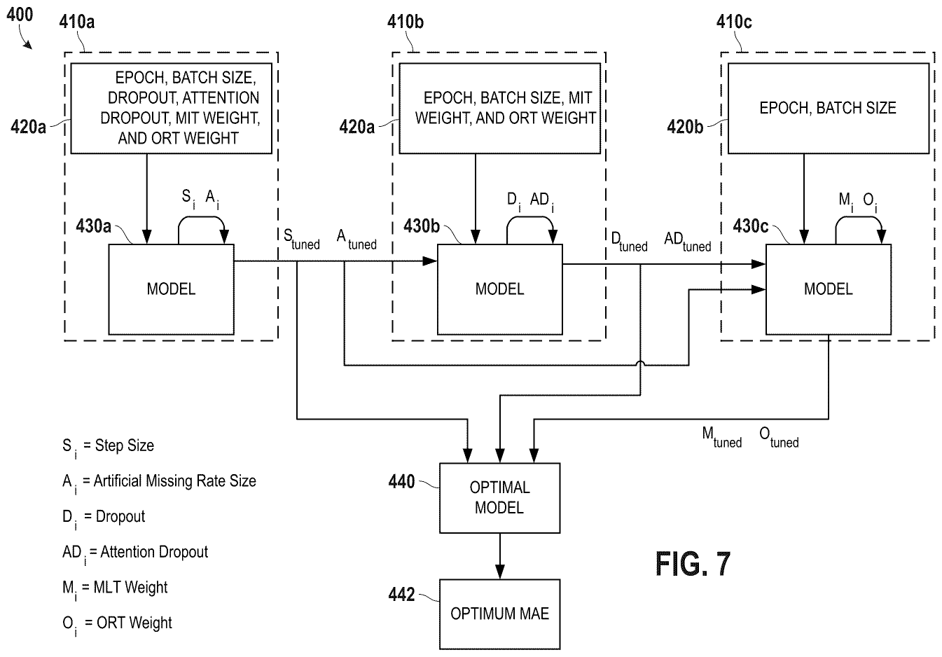

In one configuration of the present disclosure, an imputation model 130 uses a Self-Attention Imputation for Time Series (SAITS) algorithm and uses a multivariate joint optimization training process 132. In the SAITS algorithm for the imputation model 130, a self-attention mechanism learns relationships across both time steps and features of the time-series data. In the techniques of the present disclosure, the SAITS algorithm of the imputation model 130 is customized by performing uniform scaling and transformation of data after windows truncate operation to prevent data corruption. Additionally, as discussed further below with reference to FIG. 7, a three stage hyper-parameter module of the present disclosure tunes SAITS algorithm's training parameters.

The multivariate joint optimization training process 132 ensures that missing values are then imputed in a way that preserves dependencies between different features. A joint loss function at the comparison stage 128 minimizes errors for all features at once, instead of treating each variable separately.

In general, the training process 132 can use a neural network-based model to train the imputation model 130 of the present disclosure. For example, the training process 132 can use a variational autoencoder (VAE) to model missing data as latent variables with probabilistic distributions. Alternatively, the training process 132 can use a Generative Adversarial Network (GAN) having a generator-discriminator approach to impute realistic values. The training process 132 can use a transformer-based model, having attention mechanisms to capture complex dependencies in tabular data. Finally, the training process 132 can use Bayesian approaches, such as a Bayesian Network having probabilistic graphical models to infer missing values, or an expectation-maximization (EM) algorithm to iteratively estimate missing values based on maximum likelihood estimation. As shown in FIG. 3A, the imputation module 120 utilizes a joint optimization training and reconstruction approach having a masked learning task (MLT) algorithm 127a and an observed reconstruction task (ORT) algorithm 127b to learn the underlying data distribution from partially observed time series data and to estimate reasonably close missing values.

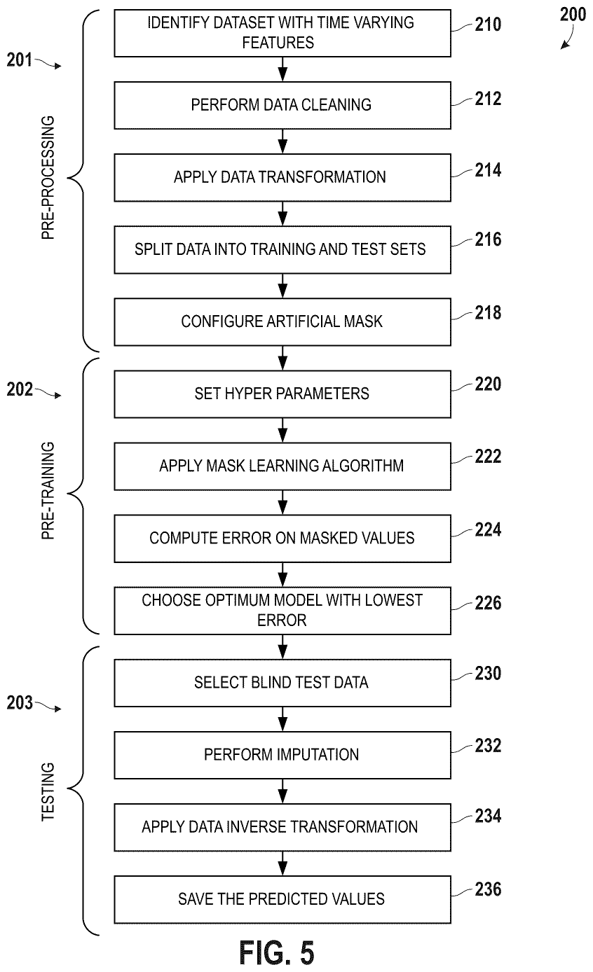

Looking at FIG. 3A in more detail, discussion turns to the workflow of the imputation module 120. (The workflow of applying the imputation module (120) to a dataset and predicting the imputed values is also detailed in FIG. 5 discussed below). In the workflow, a random mask 122 is applied to the training dataset 113a (denoted as X) to produce an artificially masked dataset 124. At an imputation stage 126, a pre-trained version of the imputation model 130 is used to impute artificial data in the masked dataset 124 to produce estimated dataset (denoted as x).

With these results, the training dataset X and the estimated dataset x are compared in a comparison stage 128 to produce a mean absolute error (MAE) value, which can be evaluated relative to an error threshold E. In the joint training process 132 of the imputation model 130, the mask learning task (MLT) algorithm 127a and the observed reconstruction task (ORT) algorithm 127b are used to learn the underlying data distribution from partially observed time series data and to estimate reasonably close missing values that minimize the error.

In the imputation module 120, for example, the training dataset X is used to train the imputation model 130, which is used to impute any datasets in further stages. The imputation module 120 uses the multivariate joint optimization training process 132 for imputation and reconstruction. Here, the term imputation refers to the process in which a missing group of “null” values in a dataset is filled, and reconstruction refers to the imputation model 130 restoring observed values in the dataset with a minimum error.

The multivariate joint optimization training process 132 disclosed herein is used to handle the missing data in the datasets. The training process 132 integrates an imputation task and a reconstruction task within a unified framework and optimizes them simultaneously to improve the quality of both. Instead of treating the imputation task and the reconstruction task as separate tasks, a joint loss function, which includes an imputation loss and a reconstruction loss, is designed to optimize both tasks at the same time. The imputation loss measures the discrepancy between actual observed values in the training dataset X and imputed values in the estimated dataset X. The reconstruction loss measures how well the trained imputation model 130 reconstructs the full data distribution, ensuring global consistency.

In the multivariate joint optimization training process 132, for instance, multiple variables (features) are optimized simultaneously within the imputation model 130, rather than treating them independently. This method is particularly useful when dealing with the multivariate time series data as is the case here, where the different features have interdependencies and correlations.

Each time step in the time series can consist of multiple features (variables). Instead of training univariate models for each feature, the training process 132 jointly learns representations for all variables. This allows the training process 132 to capture dependencies between different features. Moreover, rather than optimizing the loss for each feature separately, a single joint loss function is used to compute loss across all features. The training process 132 then updates the parameters in a way that minimizes the total loss across all features to avoid bias toward any single variable and to ensure global optimization.

Finally, a joint loss function combines errors across multiple variables, and the sum is computed across all time steps and features, ensuring a global optimization process. During the training, gradients can be computed for all parameters based on the joint loss function. An optimizer (e.g., Adam) can then update model parameters so that the total loss across all features can be minimized. This enables the training process 132 to find patterns across both temporal and cross-feature relationships.

As shown in the present example of FIG. 3A, the input data (102) can include a multivariate time-series dataset, which can be given as X={x₁, x₂, . . . , xₜ, . . . , x_{T}}∈ [symbol] with T time steps and D dimensions (representing the number of features). In the imputation module 120, the masked values in the dataset X to which the mask 122 has been applied are designated as missing mask vector M∈ [symbol] ,

$${M}_{c}^{d} = \{ \begin{matrix}1 & if {X}_{t}^{d} : observed value \\ 0 & if {X}_{t}^{d} : missed value\end{matrix}$$

As noted above, the multivariant joint optimization training process 132 uses the masked learning task (MLT) algorithm 127a and the observed reconstruction task (ORT) algorithm 127b, both of which contribute to an imputation loss measure.

In the training strategy of the MLT algorithm 127a, a portion of the training dataset X is intentionally masked (set as missing) by the artificial mask 122. The MLT algorithm 127a then predicts missing values for those artificially masked values produced by the application of the artificial mask 122. As used, the artificial mask 124 refers to a special masking of random datum during training, which makes the imputation module 120 learn a deep bidirectional pattern. The imputation module 120 may first observe some percentage (say 10%) of values batchwise and artificially masks them using the random mask 122.

The imputation model 130 is trained to predict or reconstruct these masked values. This technique helps the imputation model 130 to learn missing data patterns and dependencies in time series imputation. In the MLT algorithm 127a, a self-supervised learning approach can be used as the imputation model 130 receives the partially masked input and learns to reconstruct the missing values. A loss function (e.g., Mean Squared Error) is computed based on how well the imputation model 130 recovers the masked values.

In the training approach of the ORT algorithm 127b, the original observed values are reconstructed from the learned representations. The ORT algorithm 127b does not randomly mask additional observed values and instead receives the time series with naturally missing values. Then, self-attention encoding is used in the ORT algorithm 127b to learn representations of the time series through self-attention mechanisms. In this way, the ORT algorithm 127b can capture long-range dependencies and cross-feature relationships to ensure that the representations of the observed data are as close as possible to the original. Again, a loss function (e.g., MSE) is computed based on the difference between the reconstruction and the actual observed values.

As noted above, the trained imputation model 130 can use a SAITS algorithm to impute the missing values. (Steps associated with the SAITS algorithm are detailed in FIG. 3B discussed below). The estimated data after masking and imputation is now denoted by the estimated dataset X, and its corresponding mask vector with missing values is denoted by M stated as follows:

$${\hat{M}}_{t}^{d} = \{ \begin{matrix}1 & if {X}_{t}^{d} is observed value \\ 0 & if {X}_{t}^{d} is missed value\end{matrix}$$

An indicating mask vector/differentiates artificial missing values from original missing values represented as follows:

$${I}_{t}^{d} = \{ \begin{matrix}1 & if {X}_{t}^{d} is artificially masked \\ 0 & otherwise\end{matrix}$$

The comparison stage 128 computes a mean absolute error (MAE) value between the observed values (artificial masked) in the dataset X and the estimated dataset \hat{X}. The mean absolute error (MAE) loss can be computed as follows:

$${Loss}_{MAE} ( estimate , target , mask ) = \frac{{\sum }_{d = 1}^{D} {\sum }_{t = 1}^{T} {\vert ( estimate - target ) ⊙ mask \vert}_{t}^{d}}{{\sum }_{d = 1}^{D} {\sum }_{t = 1}^{T} {\vert mask \vert}_{t}^{d}}$$

From the MLT algorithm 127a, the masked learning task (MLT) loss can be computed as follows:

$${Loss}_{MIT} = {Loss}_{MAE} ( \tilde{X} , X , I )$$

where \tilde{X} denotes the resulting estimated time-series data after imputation.

The ORT algorithm 127b performs an estimation/reconstruction process of the observed values. These observed values are quite different from the original values. The observed reconstruction task (ORT) Loss can be computed as follows:

$${Loss}_{ORT} = {Loss}_{MAE} ( \tilde{X} , X , \hat{M} )$$

In the end, the training process 132 trains the imputation model 130 to predict missing values using the MLT algorithm 127a and the ORT algorithm 127b so the data distribution converges to observed data.

At the same time in the imputation module 120 of FIG. 3A, the trained imputation model 130 receives the test dataset from the data splitting module 112 and produces an imputed dataset 134. An inverse transform 136 transforms the imputed dataset into time-series data, which is output to the failure prediction module 140 for failure prediction.

As further shown in FIG. 3A, the failure prediction module 140 includes a machine learning (ML) model 142, which produces failure predictions 144 as described herein. In the feedback loop, the model quality monitoring module 170 monitors the quality of the failure predictions 144 to trigger the data drift comparison by the data drift evaluation module 172 to threshold(s) t so a retraining module (174) can be initiated if necessary.

### C. SELF-ATTENTION IMPUTATION FOR TIME SERIES (SAITS) ALGORITHM

Having an understanding of the imputation module 120 of FIG. 3A, discussion turns to FIG. 3B showing a Self-Attention Imputation for Time Series (SAITS) algorithm 180, which can be used for the disclosed imputation model (130).

During input handling, the SAITS algorithm 180 receives the incomplete time series data matrix X∈R^{T×D}, where T represents the number of time steps, and D represents the number of features (variables) (Block 181). Being incomplete, time series data matrix X has missing values, which can be represented as “null.” The SAITS algorithm 180 constructs a binary mask matrix M∈{0,1}^{T×D} to indicate observed and missing values in which: M_{i,j}=1 if X_{i,j} is observed, and M_{i,j}=0 if X_{i,j} is missing (Block 182).

During data pre-processing (Block 183), the input time series data is normalized or scaled (if necessary), and timestamps are encoded (if applicable) for temporal position information. For example, min-max scaling or z-score normalization can be applied to ensure numerical stability. In timestamp encoding, timestamps can be converted into features using techniques, such as positional encoding or sinusoidal encoding to capture periodicity.

The SAITS algorithm 180 now performs positional encoding and input embedding (Block 184). The raw input features are transformed into an embedded representation. For example, each feature vector Xₜ at time t is mapped into a high-dimensional space. Positional encoding is applied to any incorporate temporal information. Standard self-attention mechanisms in transformers do not capture the order of data naturally, so positional encodings (sinusoidal functions or learned embeddings) are used to help retain temporal information.

An encoder process (Blocks 185 to 189) now follows. In the encoder process, the input H, which has been pre-processed into a contextualized representation of the time series data including both observed values and positional encoding, is passed through multiple stacked transformer encoder layers (Block 185). The input H includes the observed time series data X, the mask matrix M indicating missing values, and the positional encoding P capturing the time step information.

The input representation to the encoder is:

$$H = {f}_{embed} ( X , M , P )$$

where f_{embed} is an embedding function that integrates the time series values, positional encodings, and the mask information.

Each transformer encoder layer performs a multi-head self-attention (MHSA) computation to capture dependencies across time steps (Block 186). Each transformer encoder layer uses a feedforward network to apply a non-linear transformation (Block 187), and each transformer encoder layer also maintains residual connections and layer normalization to prevent gradient vanishing and improve stability (Block 188). Stacking the transformer encoder layers enhances the SAITS algorithm's ability to learn complex temporal dependencies.

In Block 186, the MHSA computation computes attention scores to model dependencies across the time steps and computes relationships between different time steps, helping the model capture dependencies across time. To do this, the attention mechanism in the MHSA computation projects each input vector Xₜ vector into: a query matrix Q (determining which parts of the input sequence to focus on when computing attention), a Key matrix K (determining the relevance of different time steps when computing attention scores), and value matrix V (carrying the actual information to be weighted and aggregated based on computed attention scores). Attention scores are computed as:

$$Attention ( Q , K , V ) = softmax ( \frac{{QK}^{T}}{\sqrt{{d}_{kl}}} ) V$$

where Q=HW_{Q}, K=HW_{K}, V=HW_{V} and W refers to the learned weight matrices used to transform the input data H into the Q, K, and V matrices through linear projections.

The output of self-attention contains weighted combinations of past time steps that contribute most to the missing value imputation. The multiple attention heads allow the model to focus on different aspects of the data.

The Feedforward Network (FFN) (Block 187), which is a two-layer fully connected network, applies a non-linear transformation to the attention output:

$$FFN ( H ) = σ ( {HW}_{1} + {b}_{1} ) {W}_{2} + {b}_{2}$$

This step improves the expressiveness of the model.

With respect to maintaining residual connections and layer normalization (Block 188), each layer includes: residual connections that avoid vanishing gradients, and layer normalization that stabilizes learning. Thus, after each Transformer encoder layer:

$${H}_{next} = LayerNorm ( FFN ( MSHA ( H ) ) + H )$$

where H is the input representation at the current layer.

A weighted self-attention learning step (Block 189) assigns learnable attention weights to different time steps and feature dimensions. This captures long-range dependencies and cross-feature relationships so more relevant information in the data can be prioritized.

Decoder and reconstruction steps (Block 190) reconstruct the complete time series by feeding encoded representations through a decoder or linear layer. As noted, the self-attention module outputs representations that encode temporal dependencies. Accordingly, these are passed through a linear decoder (or simple feedforward layers) to reconstruct the missing values. The mask matrix M is used to ensure imputed values replace only missing entries.

A loss computation step (Block 191) computes the loss using observed values. For example, the loss function can use Mean Squared Error computed only for observed values. An optimization step (Block 192) uses backpropagation and gradient descent. For example, an Adam optimizer is used to update the model weights. This can minimize the reconstruction error over multiple training epochs. In the optimization step (Block 192), gradient-based optimization (e.g., SGD, Adam) can minimize the combined loss function iteratively. Local imputation accuracy can be balanced with global reconstruction quality to ensure that imputed values are both statistically consistent and useful for downstream tasks. Finally, a post-processing step (Block 193) reverses any normalization or scaling (if applied). As a result, the imputed values are within reasonable physical or statistical bounds.

### D. TESTING FAILURE PREDICTION

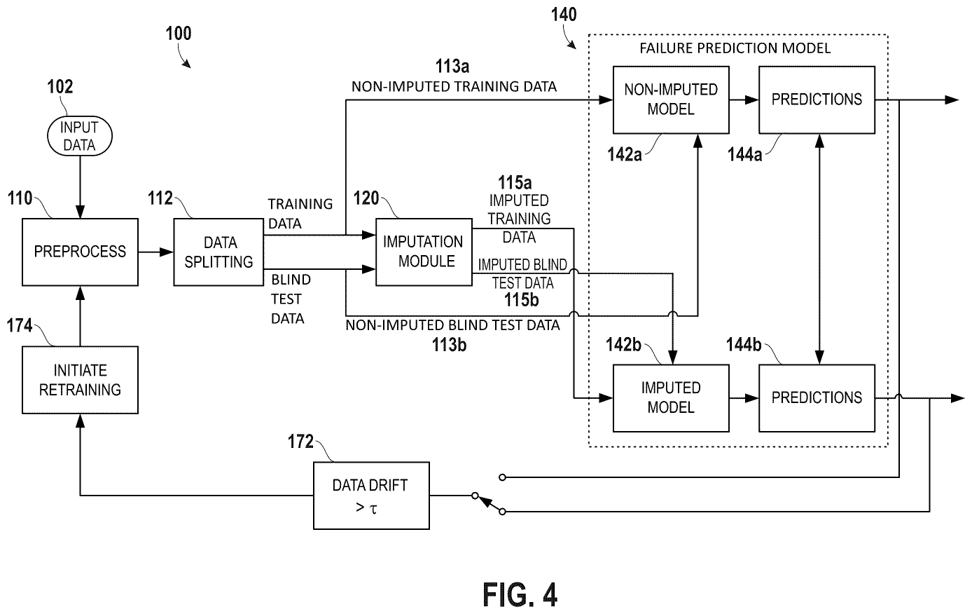

Turning to additional details of the present disclosure, FIG. 4 illustrates an example of using imputation for testing a failure prediction module 140 according to the present disclosure. Portions of the analytics framework 100 are reproduced in FIG. 4, including the pre-processing module 110, the data splitting module 112, the imputation module 120, the failure prediction module 140, and the feedback loop. Operation of the analytics framework 100 proceeds as before.

As shown in the failure prediction module 140, a non-imputed model 142a receives non-imputed training data 113a from the pre-processing module 110 and the data splitting module 112 to generate first predictions 144a. Additionally, an imputed model 142b receives imputed training data 115a from the imputation module 120 to generate second predictions 144b. Interrelated comparisons are made between the first and second predictions 144a-b using both non-imputed test data 113b and imputed test data 115b. Both of the two sets of predictions 144a-b are compared in the data drift evaluation module 172 to determine if a retraining module (174) should be initiated.

The non-imputed model 142a and the imputed model 142b are both failure prediction machine learning models. In one example, these models 142a-b can use a classification model trained to predict the presence/absence of a failure. The non-imputed model 142a is trained with the original (non-imputed) training dataset, whereas the imputed model 142b is trained with the imputed training dataset. As noted, the failure predictions 144a-b are carried out on both non-imputed and imputed test datasets. Each of the failure predictions 144a-b can act as an alert fed to the autonomous control logic (152; FIG. 2) and the model quality monitoring module (170; FIG. 2).

The failure prediction module 140 performs a feature discovery step, an exploratory data analysis step, a modelling step, and an evaluation step. The feature discovery step computes extra features, such as average, sum, and standard deviation difference for temporal rolling features. The exploratory data analysis step decides what features having high feature correlation are to be used for the modelling step. The failure prediction module 140 is evaluated using accuracy, precision, and average prediction windows. By comparing the failure predictions 144a-b, the failure prediction module can evaluate the failure prediction models 142a-b.

### E. IMPUTATION PROCESS

FIG. 5 illustrates a process 200 of pre-processing, pre-training, and testing the imputation of missing data according to the present disclosure. The process 200 includes three stages. In a pre-processing stage 201, data in the dataset is pre-processed, and an artificial mask is configured. In the pre-training stage 202, the hyper-parameters for the imputation model (130) are set. The masked learning task (MLT) algorithm (127a) and the observed reconstruction task (ORT) algorithm (127b) are applied to the mask, and values are estimated with the least error, giving a pre-trained imputation model (130) to impute data into the test dataset. In a testing stage 203, the process 200 imputes imputed data for any missing data in the test dataset, transforms the data to restore the characteristics, such as shape, order, etc. The imputed results are then saved for later use.

Looking in more detail, the pre-processing stage 201 begins with identifying a dataset with time varying features (Block 210). Data cleaning is performed (Block 212), and data transformation is applied (Block 214). The data is split into a training dataset and a test dataset (Block 216). Finally, an artificial mask is configured (Block 218).

In the pre-training stage 202, the hyper-parameters are set for the imputation model (130) (Block 220). As used here, the hyper-parameters refer to the number of steps, length of features (e.g., T time steps and D dimensions), batch size, and epochs for the imputation module (120). The mask learning task (MLT) algorithm (127a) is applied to the training dataset (Block 222), and the error of the masked values is computed (Block 224). The imputation model (130) having the lower error can then be chosen (Block 226).

In the testing stage 203, the test dataset is selected (Block 230), and the pre-trained imputation model 130 performs data imputation as discussed herein (Block 232). An inverse transformation (136) is applied to the imputed data to produce predicted values (Block 234), which can be saved for failure prediction, automated controls, etc. (Block 236).

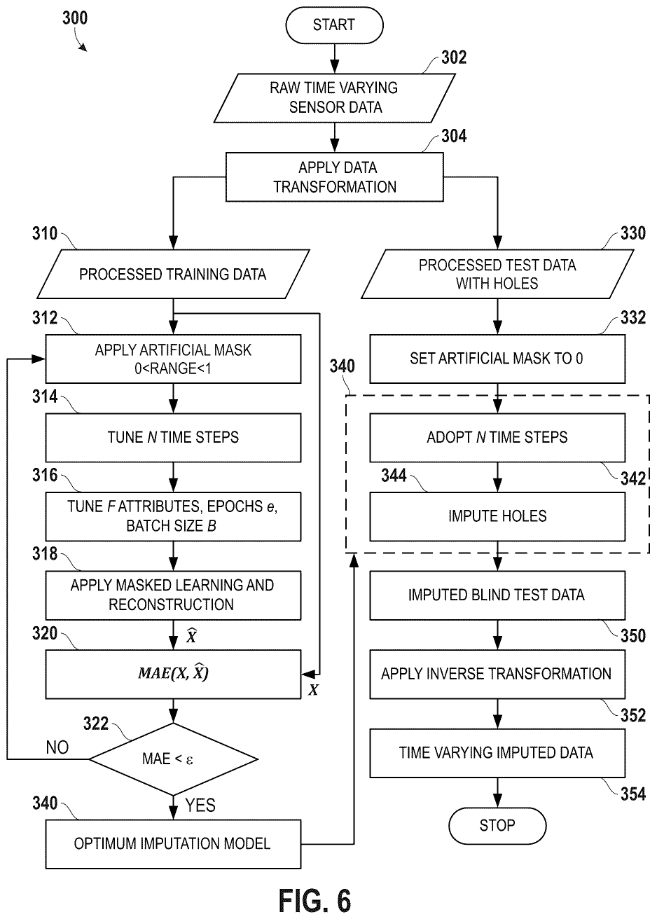

FIG. 6 illustrates a process 300 of training and testing the imputation of missing data in a dataset using the imputation module (120) according to the present disclosure. In an initial step 304 of FIG. 6, raw time varying sensor data 302 has a data transformation applied to produce a processed training dataset 310 and a processed test dataset 330. The test data 330 has missing values. However, the training dataset 310 is chosen with less missing values to prepare an efficient pre-trained imputation model (130; FIG. 3A) because the accuracy of the imputation model (130) depends on the quality of the data used in training.

Hyper-parameter tuning is performed on the processed training dataset 310 in which an artificial mask (0<range<1) is applied (Block 312), and the time steps are tuned (Block 314). The attributes F, Epochs e, and batch size B are tuned (Block 316). Masked learning and reconstruction are applied (Block 318). In Block 320, the MAE value is determined from the processed training dataset (X) and the estimated dataset (\hat{X}) of the masking and tuning. In a Decision 322, the MAE value is evaluated relative to a threshold. For example, the MAE value is computed between training dataset (X) and the estimated dataset (\hat{X}) chosen as less than 0.1, which may vary based on the magnitude of the datasets. If the MAE value is NOT below a given threshold (ε) (NO at Decision 322), then the hyper-parameter tuning and masking is performed again (Blocks 312 to 320) so a new evaluation can be made at Decision 322. Otherwise, the pre-trained imputation model (340) is completed for testing with the test dataset.

For the test dataset 330, the artificial mask is set to zero (Block 332), so data is not masked because the test dataset 330 already has missing values. The test dataset 330 is processed by the imputation model (340). In the test dataset, the time steps N from the pre-trained imputation model (340) are adopted (Block 342), and the pre-trained imputation model (340) imputes the missing values of the test dataset (Block 344) to produce an imputed test dataset (350). An inverse transform is applied (Block 352) to generate time varying imputed data (Block 354), which can then be used for the analytic functions described herein.

### F. HYPER-PARAMETER TUNING

Instead of using fixed parameters, a three-stage hyper-parameter module of the present disclosure tunes the training parameters for the SAITS algorithm (FIG. 3B). As a general example, hyper-parameters of a SAITS algorithm can include step size (Sᵢ)=200, Batch size=4, Dropout (Dᵢ)=0.1, attention dropout (ADᵢ)=0.1, weights=1, Epochs=100. In the past, a trial-and-error method was used to decide the best combination of these hyper-parameters. In contrast to the trail-and-error method, the current techniques autotune these hyper-parameters.

As noted above, the hyper-parameters of the pre-trained imputation model (340) include the number of time steps N, feature length F, Epochs E, and batch size B. These hyper-parameters control the learning process and can have a significant impact on the model's generalization and accuracy. Accordingly, these hyper-parameters are configuration parameters that are set using a three-stage hyper-parameter tuning process of the present disclosure.

Turning now to FIG. 7, a process 400 is illustrated for tuning hyper-parameters of the imputation model in three stages 410a-c according to the present disclosure. In a first stage 410a, the process 400 tunes step size Sᵢ and artificial missing rate Aᵢ based on fixed epoch E and batch size B. The first stage 410a then feeds the optimum values S_{tuned}, A_{tuned} to a second stage 410b to tune Dropout Dᵢ and Attention Dropout ADᵢ. These tuned values D_{tuned}, AD_{tuned} are then given to a third stage 410c to obtain tuned weight values M_{tuned}, O_{tuned} for the masked learning task (MLT) algorithm (127a) and observed reconstruction task (ORT) algorithm (127b). The auto-tuning reduces the time to identify and choose the best set of hyper-parameters for a specific training dataset.

In particular, in the first stage 410a, a first hyper-parameter set 420a (the Epoch E, batch size B, dropout D, attention dropout AD, MLT weight M, and ORT weight O) are input to the pre-trained imputation model 430a, which iterates on the step size Sᵢ and artificial missing rate Aᵢ. The parameters for epochs E, batch size B, dropout D, attention dropout AD, MLT weight M, and ORT weight O are fixed while the step size Sᵢ and the artificial missing rate Aᵢ are alterable. During each iteration of training i, the step size Sᵢ and the artificial missing rate Aᵢ are chosen to train the pre-trained imputation model 430a, and the MAE value is calculated. The iterative process is repeated until convergence of the MAE value is achieved so the tuned step size S_{tuned} and artificial missing rate A_{tuned} are produced.

The first stage 410a outputs of the step size S_{tuned} and artificial missing rate A_{tuned} pass to the second stage 410b. In the second stage 410b, a second hyper-parameter set 420b (epoch E, batch size B, MLT weight M, and ORT weight O) are input to the model 430b, which iterates on dropout Dᵢ and attention dropout ADᵢ. In a similar fashion, parameters for E, B, M, and O as fixed and parameters for D and AD are tuned. The model 430b is executed for each set of dropout Dᵢ and attention dropout ADᵢ to obtain the best possible search values with minimum error.

The tuned set of values, D_{tuned} and AD_{tuned}, are then fed to the third stage 410c. In the third stage 410c, a third hyper-parameter set 420c (epoch E and batch size B) are input to the model 430c, which iterates on the MLT weight Mᵢ and the ORT weight Oᵢ and outputs MLT weight M_{tuned} and ORT weight O_{tuned}. The four tuned values S_{tuned}, A_{tuned}, D_{tuned}, and AD_{tuned} are utilized in the third stage to tune the weights Mᵢ and Oᵢ. For the fixed E and B parameters, the search of Mᵢ and Oᵢ is performed until convergence. The third stage 410c obtains the best values for M, O, E and B. Hence, the three cascading stages 410a-c produce an optimum set of hyper-parameters, leading to an optimum imputation model 440 with an optimum MAE value 442.

### G. EXAMPLES

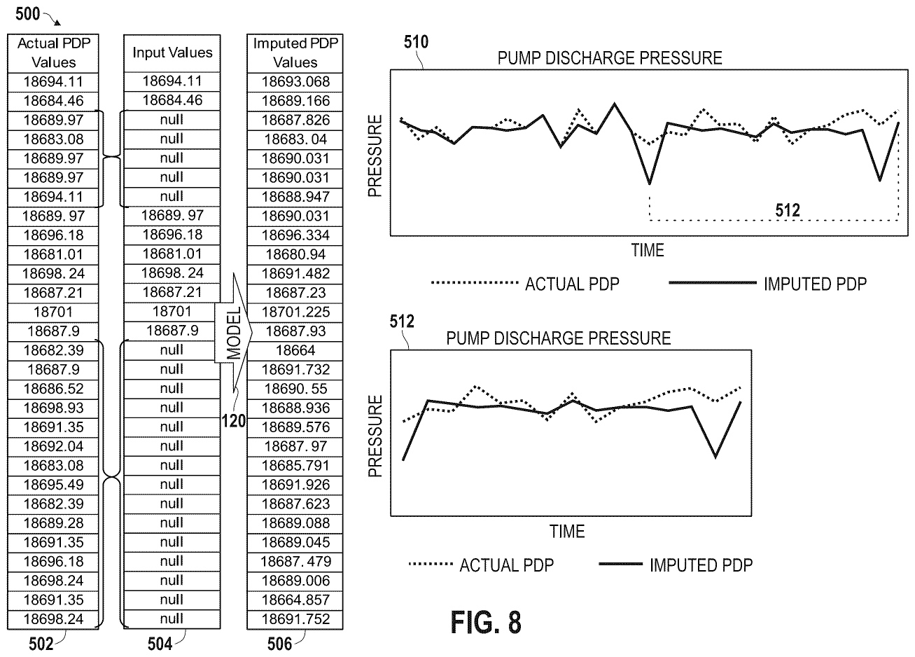

The imputation model of the present disclosure is evaluated by considering various example cases. In one example case, missing values are imputed in consecutive time stamps for a single feature. FIG. 8 shows an example case 500 for pump discharge pressure (PDP), such as measured by a sensor in an ESP system. A first dataset 502 lists actual PDP values in a time series. To test the imputation module (120) of the present disclosure, an input dataset 504 is masked, given two sections of missing PDP data labelled as “null” values in the time series. The input dataset 504 is run through the imputation module (120) of the present disclosure with the missing values in the two sections being null in the time steps. The imputation module (120) produces the imputed PDP values in an imputed dataset 506.

Graph 510 compares the actual PDP values (i.e., sensor values) and the imputed PDP values in a time series of the data. Graph 512 is a closeup of the time series in Graph 510. The PDP values and plots illustrate that imputed PDP values capture the pattern closely with minimal error.

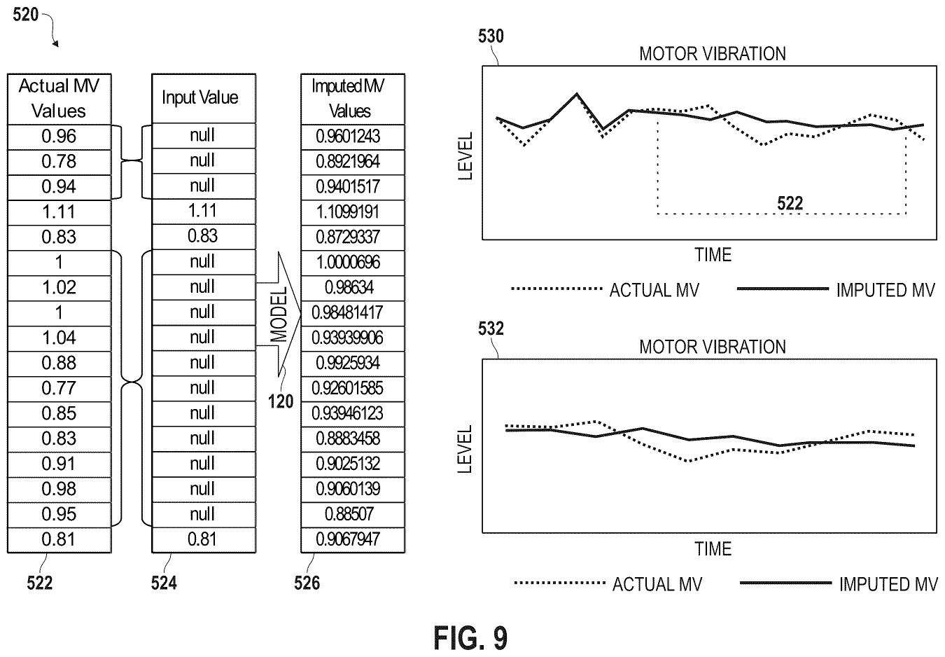

FIG. 9 shows another example case 520 for motor vibration (MV), such as measured by a sensor in an ESP system. A first dataset 522 lists actual motor vibration (MV) values in a time series. To test the imputation module (120) of the present disclosure, an input dataset 524 is masked with two sections of missing MV data, labelled as “null” in the time series and missing consecutively. The input dataset 524 is run through the imputation module (120) of the present disclosure with the missing values in the two sections being null in the time steps. The imputation module (120) produces the imputed MV values in an imputed dataset 526.

Graph 530 compares the actual MV values (i.e., sensor values) and the imputed MV values in the time series of the data. Graph 532 is a closeup of the time series in Graph 530. The MV values and plots illustrate that imputed MV values capture the pattern closely with minimal error.

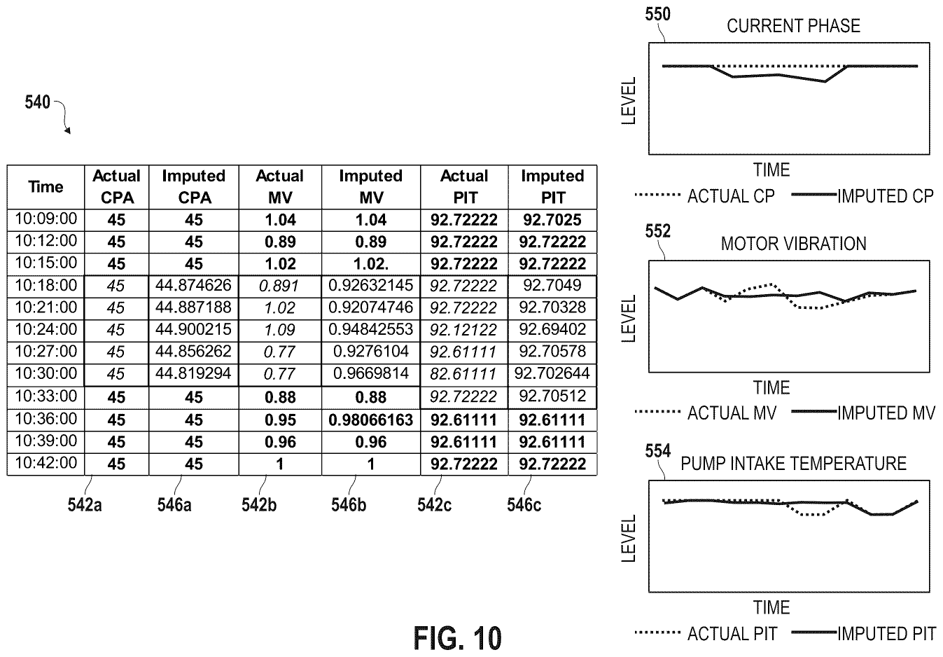

In yet another example case, missing values in several features are imputed for the same time stamps. For instance, FIG. 10 shows yet another example case 540 for current phase (CP), motor vibration (MV), and pump intake temperature (PIT), such as measured in an ESP system. First datasets 542a-c lists actual current phase (CP) values, motor vibration (MV) values, and actual pump intake temperature (PIT) values in a time series. To test the imputation module (120) of the present disclosure, input datasets are masked to have missing data labelled as “null”, but are italicised here in the time series and are missing consecutively. The input datatsets 542a-c are run through the imputation module (120) of the present disclosure with the missing values in the section being “null” in the time steps. The imputation module (120) produces the imputed CP, MV, and PIT values in imputed datasets 546a-c.

Graph 550 compares the actual CP values and the imputed CP values in the time series of the data, Graph 552 compares the actual MV values and the imputed MV values in the time series of the data, and Graph 554 compares the actual PIT values and imputed PIT values in the time series of the data. The values and plots illustrate that the imputed values 546a-c capture the patterns closely with minimal error.

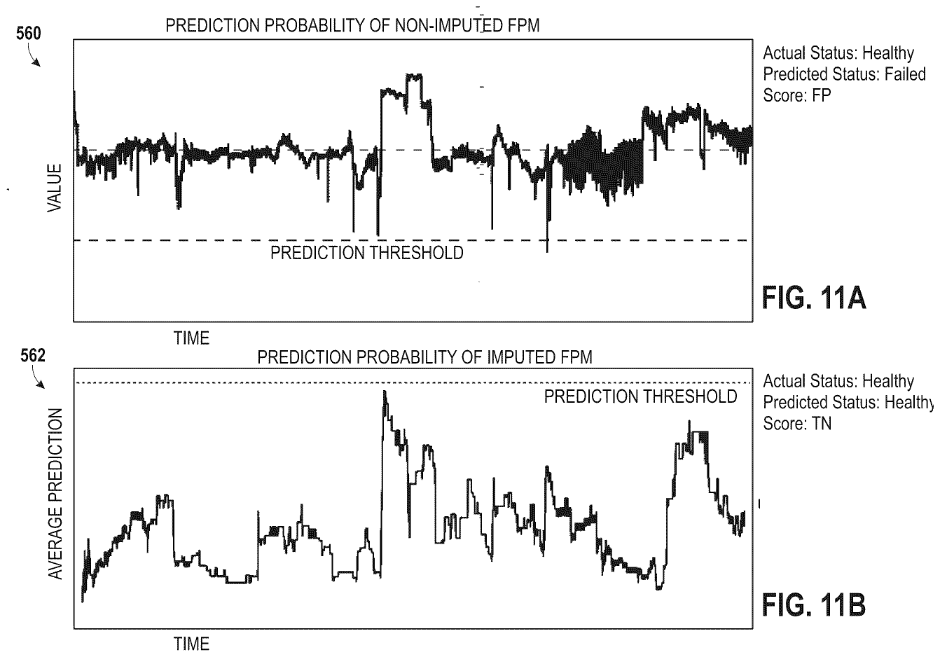

Turning now to FIGS. 11A through 13B, example results for a failure prediction module (140) according to the present disclosure are shown without and with application of the imputation module (120) of the present disclosure. FIG. 11A illustrates a prediction probability plot 560 of the failure prediction model (FPM) trained with raw sensor dataset (non-imputed FPM), whereas FIG. 11B illustrates a prediction probability plot 560 of the FPM trained with imputed sensor dataset (imputed FPM) for a first example well.

This first example well is actually a healthy well. The non-imputed FPM in FIG. 11A predicted that this healthy well as being a failed well, which has lead to a False Positive (FP) Score and a prediction probability greater than a prediction threshold. By contrast, the imputed FPM in FIG. 11B has correctly classified the healthy well with prediction probability less than prediction threshold, leading to a True Negative (TN) Score.

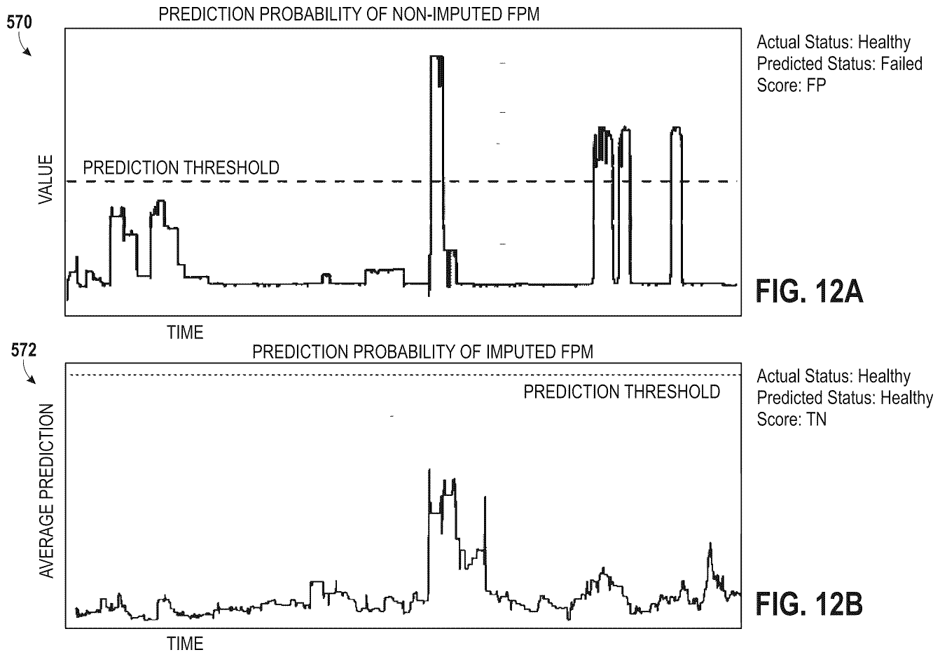

FIG. 12A depicts the prediction probability without imputation, and FIG. 12B shows the prediction probability of imputed FPM of a second example well, which is also a healthy well. In this case, high glitches in the prediction probability are nullified after imputation and are scored as True Negative (TN), as shown in FIG. 12B.

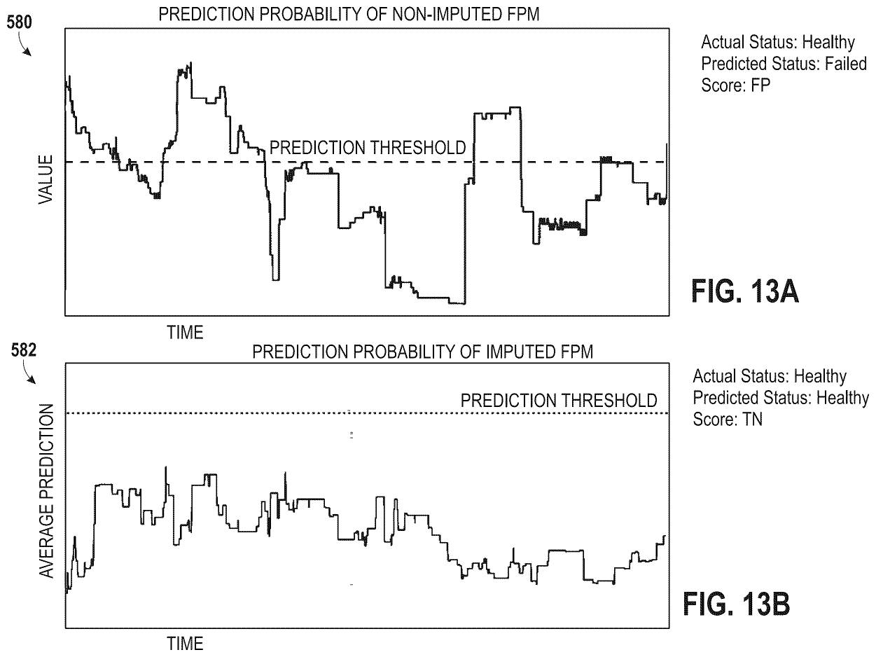

FIG. 13A depicts the prediction probability without imputation, and FIG. 13B shows the prediction probability of imputed FPM of a third example well, which is a healthy well. In this case, a high False Probability score is reported by the non-imputed FPM in FIG. 13A during early days of prediction and gradually decreasing. By contrast, the imputed FPM in FIG. 13B is scored as a True Negative.

### H. Summary

The imputation module used in the current framework overcomes the drawbacks, such as low speed and compounding errors compared to prior art sequential systems that impute corrupted data using an autoregressive recurrent neural network (RNN). The disclosed imputation module achieves better imputation quality with much faster response time. Although prior art imputation techniques lack the ability to decide the number of discontinuities in a complete dataset and the extent to be filled. The disclosed imputation module automatically decides an optimum length of missing data based on the quality of dataset that can be filled. In one of the use cases, the imputation module 120 imputes with a minimum error even if a missing rate of multiple attributes is less than 25% having a single attribute missing rate less than 50%. Qualitative and quantitative experiments demonstrate the potential of the multi-variate imputation algorithm of the present disclosure in improving the performance on incomplete time-series datasets compared to the state-of-the-art methods.

If the imputation module of the present disclosure were to be replaced with any statistical imputation technique of the prior art (Inter Quantile Ranges (IQR), gaussian distribution-based mean and covariance measures, Bayesian and voting methods), there would be a huge increase in the number of anomalies and alerts introduced into the system, affecting the overall analytics performance. Using the techniques disclosed herein, the overall precision of the failure prediction model can be improved from 72% to 87%, and overall accuracy can be improved from 67% to 78% after data imputation. Hence, there is a significant improvement of 15% precision and 11% accuracy of the present disclosure compared with results without imputation.

Configurations of the present disclosure can be characterized as follows:
1. A method implemented with processing equipment (10) associated with one or more artificial lift units (50), the method comprising:
training, with the processing equipment (10), an imputation model (130) configured to impute any missing data in a given dataset;
obtaining (181), at the processing equipment (10), raw time-series data for the one or more artificial lift units (50);
preprocessing (183), with the processing equipment (10), the raw time-series data into an evaluation dataset;
imputing (184-193), with the imputation model (130) of the processing equipment (10), imputed data for any missing data in the evaluation dataset to produce an imputed dataset (134);
predicting, with an analytics function (105) of the processing equipment (10), at least one prediction for the one or more artificial lift units (50) from the imputed dataset (134);
configuring, with the processing equipment (10), at least one automated instruction in response to the at least one prediction; and
implementing, with the processing equipment (10), the at least one automated instruction for use at the one or more the artificial lift units (50).
2. The method according to claim 1, wherein training (132) the imputation model (130) comprises:
preprocessing (110, 112) the raw time-series data (102) into a training dataset (X);
applying (122) a mask to underlying data in at least a portion of the training dataset (X) to produce masked data (124);
imputing (126), with the imputation model (130), estimated data (X″) for the masked data;
estimating (128) an error between the underlying data and the estimated data (X); and
configuring the imputation model (130) to reduce the error.
3. The method according to claim 2, wherein estimating (128) the error and configuring to reduce the error comprises computing (128) a mean absolute error (MAE) and comparing the mean absolute error (MAE) relative to a threshold (∈).
4. The method according to claim 1, 2 or 3, wherein predicting, with the analytics function (140, 150, 160) of the processing equipment (10), the at least one prediction for the one or more artificial lift units (50) from the imputed dataset (134) comprises:
training a first failure prediction model (142a) of the analytics function with first data that is non-imputed;
training a second failure prediction model (142b) of the analytics function with second data that is imputed;
preprocessing (110, 112) the raw time-series data (102) into a training dataset (113a) and a test dataset (113b);
predicting, with the first failure prediction model (142a), first failure predictions (144a) from non-imputed versions of the training dataset (113a) and the test dataset (113b);
imputing, with the imputation model (130), imputed versions of the training dataset and the test dataset;
predicting, with the second failure prediction model (142b), second failure predictions (144b) from the imputed versions of the training dataset and the test dataset;
correlating between the first and second failure predictions (144a-b); and
configuring the at least one prediction based on the correlation.
5. The method according to any one of claims 1 to 4, wherein preprocessing (110) the raw time-series data (102) into the evaluation dataset comprises splitting (112) the evaluation dataset into a training dataset (113a) and a test dataset (113b); wherein imputing comprises imputing any missing data in the test dataset (113b) to produce an imputed test dataset (123); and wherein the method further comprises:
discovering (172) a data drift by comparing the training dataset (113a) with the imputed test dataset (123); and
retraining (174) the imputation model (130) in response to the data drift.
6. The method according to any one of claims 1 to 5, wherein the analytics function (105) comprises autonomous control logic (152); wherein configuring the at least one automated instruction in response to the at least one prediction comprises configuring an autonomous control from the autonomous control logic (152); and wherein implementing the at least one automated instruction comprises communicating the autonomous control from a first processing device (60) of the processing equipment (10) to at least one second processing device (20) associated with the one or more artificial lift units (50), the autonomous control being configured to be performed at the at least one second processing device (20, 30, 40).
7. The method according to any one of claims 1 to 6, wherein the analytics function (105) comprises an alarm function (150); wherein predicting the at least one prediction comprises predicting an alarm condition; wherein configuring the at least one automated instruction comprises configuring alarm information for the at least one automated instruction in response to the alarm condition; and wherein implementing the at least one automated instruction comprises communicating the alarm information from a first processing device (60) of the processing equipment (10) to at least one second processing device (20, 30, 40) associated with the one or more artificial lift units (50), the alarm information being configured to be used at the at least one second processing device (20, 30, 40).
8. The method according to any one of claims 1 to 7, wherein the analytics function (105) comprises a failure prediction function (140); wherein predicting the at least one prediction comprises predicting a failure condition; wherein configuring the at least one automated instruction comprises configuring the at least one automated instruction to counteract the failure condition; and wherein implementing the at least one automated instruction comprises communicating the at least one automated instruction from a first processing device (60) of the processing equipment (10) to at least one second processing device (20, 30, 40) associated with the one or more artificial lift units (50), the at least one automated instruction being configured to be used at the at least one second processing device (20, 30, 40) to counteract the predicted failure condition.
9. The method of claim 8, wherein the predicted failure condition comprises at least one of: an equipment/component failure of the one or more artificial lift units (50); a failure of a well at a wellsite of the one or more artificial lift units (50); an inefficiency of the one or more artificial lift units (50); and a decline in production of the one or more artificial lift units (50).
10. The method according to any one of claims 1 to 9, wherein training, with the processing equipment (10), the imputation model (130) comprises:
in a pre-processing stage (201), pre-processing (304) raw time varying sensor data (302) into a training dataset (X, 310) and a test dataset (330), test data in the test dataset (330) having missing values, training data in the training dataset (310) having fewer missing values;
in a pre-training stage (202) using the training dataset (310),
applying (312) an artificial mask, tuning hyper-parameters (220, 314, 316), and applying a masked learning algorithm (222, 318) to produce an estimated dataset (X′); and
evaluating an error between the training dataset (X, 310) and the estimated dataset (X′), and choosing (226) a pre-trained imputation model (340) based on the evaluation; and
in a testing stage (202) using the test dataset 330, imputing (232, 344) the missing values of the test dataset (330) using the pre-trained imputation model (340) to produce an imputed test dataset (350), and generating time varying imputed test data (354) for use by the analytic functions (105) by applying (234, 352) an inverse transform to the imputed test dataset (350).
11. The method according to any one of claims 1 to 10, wherein imputing, with the imputation model (130) of the processing equipment (10), the imputed data for any missing data in the evaluation dataset to produce the imputed dataset (134) comprises imputing the imputed data with a Self-Attention Imputation for Time Series (SAITS) algorithm for the imputation model (130).
12. The method of claim 11, wherein training the imputation model (130) comprises learning relationships across time steps and features, and preserving dependencies between the features by minimizing errors for all of the features at once with a joint loss function in a multivariate joint optimization training process.
13. The method of claim 12, wherein learning the relationships across the time steps and the features comprises learning, in self-supervised learning of a masked learning task (MLT) algorithm, from underlying patterns in input data and the dependencies between the time steps and the features to reconstruct masked values of the input data based on an indication in the joint loss function of how well the masked values are recovered; and wherein preserving the dependencies between the features comprises reconstructing, in self-attention encoding of an observed reconstruction task (ORT) algorithm, a reconstruction of observed values in the input data (102) based on a difference in the joint loss function between the reconstruction and the observed values.
14. The method of claim 11, 12 or 13, comprising tuning (400) hyperparameters of step size, artificial missing rate size, epoch, batch size, dropout, attention dropout, and weighting for the Self-Attention Imputation for Time Series (SAITS) algorithm by:
iterating on the step size and the artificial missing rate size in a first stage (410a) to tune a tuned step size and a tuned artificial missing rate size while the Epoch, the batch size, the dropout, the attention dropout, and the weighting are fixed;
iterating on the dropout and the attention dropout in a second stage (410b) to tune a tuned dropout and a tuned attention dropout while using the tuned step size and the tuned artificial missing rate size from the first stage (410a) and while the Epoch, the batch size, and the weighting are fixed; and
iterating on the weighting in a third stage (410c) to tune a weighting while using the tuned step size, the tuned artificial missing rate size and while the Epoch and the batch size are fixed.
15. For one or more artificial lift units (50), a programmable storage device having program instructions stored thereon for causing processing equipment (10) to perform a method according to any one of claims 1 to 14.
16. A system for one or more artificial lift units (50), the system (10) comprising:
communication equipment (32, 62) having network interfaces in communication with one or more networks; and
processing equipment (10) in communication with the communication equipment (32, 62), the processing equipment (10) being configured to perform a method according to any one of claims 1 to 14.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A method implemented with processing equipment associated with one or more artificial lift units, the method comprising:
training, with the processing equipment, an imputation model configured to impute any missing data in a given dataset;
obtaining, at the processing equipment, raw time-series data for the one or more artificial lift units;
pre-processing, with the processing equipment, the raw time-series data into an evaluation dataset;
imputing, with the imputation model of the processing equipment, imputed data for any missing data in the evaluation dataset to produce an imputed dataset;
predicting, with an analytics function of the processing equipment, at least one prediction for the one or more artificial lift units from the imputed dataset;
configuring, with the processing equipment, at least one automated instruction in response to the at least one prediction; and
implementing, with the processing equipment, the at least one automated instruction for use at the one or more the artificial lift units.

2. The method of claim 1, wherein training the imputation model comprises:
preprocessing the raw time-series data into a training dataset;
applying a mask to underlying data in at least a portion of the training dataset to produce masked data;
imputing, with the imputation model, estimated data for the masked data;
estimating an error between the underlying data and the estimated data; and
configuring the imputation model to reduce the error.

3. The method of claim 2, wherein estimating the error and configuring to reduce the error, for example comprises computing a mean absolute error and comparing the mean absolute error relative to a threshold.

4. The method of claim 1, wherein predicting, with the analytics function of the processing equipment, the at least one prediction for the one or more artificial lift units from the imputed dataset comprises:
training a first failure prediction model of the analytics function with first data that is non-imputed;
training a second failure prediction model of the analytics function with second data that is imputed;
preprocessing the raw time-series data into a training dataset and a test dataset;
predicting, with the first failure prediction model, first failure predictions from non-imputed versions of the training dataset and the test dataset;
imputing, with the imputation model, imputed versions of the training dataset and the test dataset;
predicting, with the second failure prediction model, second failure predictions from the imputed versions of the training dataset and the test dataset;
correlating between the first and second failure predictions; and
configuring the at least one prediction based on the correlation.

5. The method of claim 4, wherein predicting, with the analytics function of the processing equipment, the at least one prediction for the one or more artificial lift units from the imputed dataset comprises predicting, with an anomaly detection function, an anomaly, with imputed versions of the training dataset and the test dataset.

6. The method of claim 1, wherein preprocessing the raw time-series data into the evaluation dataset comprises splitting the evaluation dataset into a training dataset and a test dataset; wherein imputing comprises imputing any missing data in the test dataset to produce an imputed test dataset; and wherein the method further comprises:
discovering a data drift by comparing the training dataset with the imputed test dataset; and
retraining the imputation model in response to the data drift.

7. The method of claim 1, wherein the processing equipment comprises one or more of: a distributed processing system connected together by one or more networks, a client-server system connected together by one or more networks, an enterprise processing system connected to one or more networks, a local processing device connected locally to the one or more artificial lift units; and a remote processing device connected remotely to one or more local processing devices for the one or more artificial lift units.

8. (canceled)

9. The method of claim 1, wherein the analytics function comprises autonomous control logic; wherein configuring the at least one automated instruction in response to the at least one prediction comprises configuring an autonomous control from the autonomous control logic; and wherein implementing the at least one automated instruction comprises communicating the autonomous control from a first processing device of the processing equipment to at least one second processing device associated with the one or more artificial lift units, the autonomous control being configured to be performed at the at least one second processing device.

10. The method of claim 1, wherein configuring the at least one automated instruction comprises configuring an updated version of the analytics function; and wherein implementing the at least one automated instruction comprises communicating the updated version of the analytics function from a first processing device of the processing equipment to at least one second processing device associated with the one or more artificial lift units, the updated version being configured to install on the at least one second processing device.

11. The method of claim 1, wherein the analytics function comprises an alarm function; wherein predicting the at least one prediction comprises predicting an alarm condition; wherein configuring the at least one automated instruction comprises configuring alarm information for the at least one automated instruction in response to the alarm condition; and wherein implementing the at least one automated instruction comprises communicating the alarm information from a first processing device of the processing equipment to at least one second processing device associated with the one or more artificial lift units, the alarm information being configured to be used at the at least one second processing device.

12. The method of claim 1, wherein the analytics function comprises a failure prediction function; wherein predicting the at least one prediction comprises predicting a failure condition; wherein configuring the at least one automated instruction comprises configuring the at least one automated instruction to counteract the failure condition; and wherein implementing the at least one automated instruction comprises communicating the at least one automated instruction from a first processing device of the processing equipment to at least one second processing device associated with the one or more artificial lift units, the at least one automated instruction being configured to be used at the at least one second processing device to counteract the predicted failure condition.

13. (canceled)

14. The method of claim 1, wherein training, with the processing equipment, the imputation model comprises:
in a pre-processing stage, pre-processing raw time varying sensor data into a training dataset and a test dataset, test data in the test dataset having missing values, training data in the training dataset having fewer missing values;
in a pre-training stage using the training dataset,
applying an artificial mask, tuning hyper-parameters, and applying a masked learning algorithm to produce an estimated dataset; and
evaluating an error between the training dataset and the estimated dataset, and choosing a pre-trained imputation model based on the evaluation; and
in a testing stage using the test dataset, imputing the missing values of the test dataset using the pre-trained imputation model to produce an imputed test dataset, and generating time varying imputed test data for use by the analytic functions by applying an inverse transform to the imputed test dataset.

15. The method of claim 1, wherein imputing, with the imputation model of the processing equipment, the imputed data for any missing data in the evaluation dataset to produce the imputed dataset comprises imputing the imputed data with a Self-Attention Imputation for Time Series algorithm for the imputation model.

16. The method of claim 15, wherein training the imputation model comprises learning relationships across time steps and features, and preserving dependencies between the features by minimizing errors for all of the features at once with a joint loss function in a multivariate joint optimization training process.

17. The method of claim 16, wherein learning the relationships across the time steps and the features comprises learning, in self-supervised learning of a masked learning task (MLT) algorithm, from underlying patterns in input data and the dependencies between the time steps and the features to reconstruct masked values of the input data based on an indication in the joint loss function of how well the masked values are recovered.

18. The method of claim 17, wherein preserving the dependencies between the features comprises reconstructing, in self-attention encoding of an observed reconstruction task (ORT) algorithm, a reconstruction of observed values in the input data based on a difference in the joint loss function between the reconstruction and the observed values.

19. The method of claim 15, comprising tuning hyperparameters of step size, artificial missing rate size, epoch, batch size, dropout, attention dropout, and weighting for the Self-Attention Imputation for Time Series algorithm by:
iterating on the step size and the artificial missing rate size in a first stage to tune a tuned step size and a tuned artificial missing rate size while the Epoch, the batch size, the dropout, the attention dropout, and the weighting are fixed;
iterating on the dropout and the attention dropout in a second stage to tune a tuned dropout and a tuned attention dropout while using the tuned step size and the tuned artificial missing rate size from the first stage and while the Epoch, the batch size, and the weighting are fixed; and
iterating on the weighting in a third stage to tune a weighting while using the tuned step size, the tuned artificial missing rate size and while the Epoch and the batch size are fixed.

20. The method of claim 19, wherein the weighting includes a first weight for a masked learning task (MLT) algorithm and a second weight for an observed reconstruction task (ORT) algorithm.

21. For one or more artificial lift units, a programmable storage device having program instructions stored thereon for causing processing equipment to perform a method according to claim 1.

22. A system for one or more artificial lift units, the system comprising:
communication equipment having network interfaces in communication with one or more networks; and
processing equipment in communication with the communication equipment, the processing equipment being configured to:
train an imputation model configured to impute any missing data in a given dataset;
obtain raw time-series data for the one or more artificial lift units;
preprocess the raw time-series data into an evaluation dataset;
impute, with the imputation model, imputed data for any missing data in the evaluation dataset to produce an imputed dataset;
predict, with an analytics function, at least one prediction for the one or more artificial lift units from the imputed dataset;
configure at least one automated instruction in response to the at least one prediction; and
implement the at least one automated instruction for use at the one or more the artificial lift units.
